(19) United States
(12) Patent Application Publication
(10) Pub. No.: US 2026/0095390 A1
(43) Pub. Date: Apr. 2, 2026

(54) SYSTEM AND METHOD FOR VALIDATING SOFTWARE UPGRADES AND OPTIMIZING NETWORK PATH MAPPING

(71) Applicant: Samsung Electronics Co., Ltd., Suwon-si (KR)

(72) Inventors: Karthikeyan SUBRAMANIAM, Bangalore (IN); Deepanshu GAUTAM, Bangalore (IN); Senthilkumar SUBRAMANIAN, Bangalore (IN); Ashutosh KAUSHIK, Bangalore (IN); Chittaranjan SAHOO, Bangalore (IN)

(21) Appl. No.: 19/410,616

(22) Filed: Dec. 5, 2025

Related U.S. Application Data
(63) Continuation of application No. PCT/KR2024/015321, filed on Oct. 8, 2024.

(30) Foreign Application Priority Data
Oct. 10, 2023 (IN) 202341067992
Oct. 4, 2024 (IN) 2023 41067992

(51) Int. Cl. H04L 41/16; H04L 47/2483

(52) U.S. Cl. CPC H04L 41/16; H04L 47/2483

(57) ABSTRACT

A system and a method for validating software upgrades and optimizing network path mapping are provided. Further, a method for validating a software upgrade and determining network path mapping at a network entity (NE) using a management data analytics service (MDAS) producer is provided. The method includes predicting a set of key performance indicators (KPIs) using a machine learning (ML) model, performing a software upgrade, determining KPIs associated with the NE post-upgrade, comparing the predicted and determined KPIs, and the software upgrade is validated, receiving network traffic information reflecting network performance metrics for various paths, and predicting a plurality of KPIs using the ML model, and determines the optimal network paths based on the predicted KPIs.

### CROSS-REFERENCE TO RELATED APPLICATION(S)

This application is a continuation application, claiming priority under 35 U.S.C. § 365 (c), of an International application No. PCT/KR2024/015321, filed on Oct. 8, 2024, which is based on and claims the benefit of an Indian Provisional patent application No. 202341067992, filed on Oct. 10, 2023, in the Indian Intellectual Property Office, and of an Indian Complete patent application No. 202341067992, filed on Oct. 4, 2024, in the Indian Intellectual Property Office, the disclosure of each of which is incorporated by reference herein in its entirety.

### BACKGROUND

### 1. Field

The disclosure relates to a field of network management and optimization. More particularly, the disclosure relates to a system and method for validating software upgrades and optimizing network path mapping in telecommunication networks.

### 2. Description of Related Art

For the deployment, operation, and optimization of 5th generation (5G) communication networks and future mobile networks and services, increasingly complex use cases and advanced services are emerging. Alongside these developments, end users are demanding greater data capacity, faster speeds, lower latency, reliable connectivity, and improved energy efficiency. These factors are driving a new era of challenges for mobile network operators, requiring continuous improvements to meet these expectations. To address these demands, an operations, administration, and management (OAM) system must be significantly enhanced. The OAM system needs to incorporate intelligence and enable full automation to support advanced use cases and services. An ultimate goal is to achieve near-zero-touch network and service management, as well as orchestration, making a network more adaptive and efficient in operations. Since Release 15 (Rel-15) and Release 16 (Rel-16) timeframes, a 3rd generation partnership project (3GPP) service and system aspects (SA) working group 5 (WG5) has been actively developing features for a management data analytics (MDA) feature.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a system and method for validating software upgrades and optimizing network path mapping in telecommunication networks.

Additional aspects will be set forth in part in the description which follows and, in part, will be apparent from the description, or may be learned by practice of the presented embodiments.

In accordance with an aspect of the disclosure, a method performed by a network node for a management data analytics service (MDAS) is provided. The method includes obtaining, using a machine learning (ML) model, a first set of key performance indicators (KPIs) required to perform validation of the software upgrade, performing the software upgrade at the NE, determining a second set of KPIs associated with the NE after performing the software upgrade at the NE, and comparing the predicted first set of KPIs and the determined second set of KPIs.

In accordance with another aspect of the disclosure, a method performed by a network node for a management data analytics service (MDAS) is provided. The method includes obtaining network traffic information indicating network performance metrics for network traffic of one or more network paths on a network, obtaining, using a machine learning (ML) model, a plurality of key performance indicators (KPIs) based on obtained network traffic information, and determining at least one network path based on the obtained plurality of KPIs.

In accordance with another aspect of the disclosure, a network node for a management data analytics service (MDAS) is provided. The system includes memory, including one or more storage media, storing instructions, and at least one processor, including processing circuitry, communicatively coupled to the memory, wherein the instructions, when executed by the at least one processor individually or collectively, cause the network node to obtain, using a time series model, a first set of key performance indicators (KPIs) required to perform validation of the software upgrade, perform the software upgrade at the NE, determine a second set of KPIs associated with the NE after performing the software upgrade at the NE and compare the predicted first set of KPIs and the determined second set of KPIs.

In accordance with another aspect of the disclosure, a network node for a management data analytics service (MDAS) is provided. The system includes memory, including one or more storage media, storing instructions, and at least one processor, including processing circuitry, communicatively coupled to the memory, wherein the instructions, when executed by the at least one processor individually or collectively, cause the network node to obtain network traffic information indicating network performance metrics for network traffic of one or more network paths on a network, obtain, using a machine learning (ML) model, a plurality of key performance indicators (KPIs) based on the obtained network traffic information, and determine one or more optimal network paths based on the predicted plurality of KPIs.

In accordance with another aspect of the disclosure, one or more non-transitory computer-readable storage media storing one or more computer programs including computer-executable instruction that, when executed by one or more processors of a network node for a management data analytics service (MDAS) individually or collectively, cause the network node to perform operations are provided. The operations include memory, including one or more storage media, storing instructions, and at least one processor, including processing circuitry, communicatively coupled to the memory, wherein the instructions, when executed by the at least one processor individually or collectively, cause the network node to obtain network traffic information indicating network performance metrics for network traffic of one or more network paths on a network, obtain, using a machine learning (ML) model, a plurality of key performance indicators (KPIs) based on the obtained network traffic information, and determine at least one network path based on the obtained plurality of KPIs.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a high-level management data analytics (MDA) architecture according to the related art;

FIG. 2 illustrates a sequence flow of data between various entities of an MDA architecture according to the related art;

FIG. 3 illustrates a fifth generation (5G) architecture with a point-to-point interface according to the related art;

FIG. 4 illustrates a block diagram of a network environment for validation of software upgrades and optimization of network path mapping according to an embodiment of the disclosure;

FIG. 5 illustrates components of a software upgrade validation framework of a 5G radio access network (RAN) node according to an embodiment of the disclosure;

FIG. 6 illustrates a 5G architecture for network topology mapping according to an embodiment of the disclosure;

FIG. 7 illustrates a block diagram of a network entity (NE) to validate software upgrades and optimize a network path mapping in a telecommunication network according to an embodiment of the disclosure;

FIG. 8 is a flow diagram illustrating a method that includes operations associated with a NE for performing validation of a software upgrade utilizing a management data analytics service (MDAS) producer according to an embodiment of the disclosure;

FIG. 9 is a flow diagram illustrating a method that includes operations associated with a NE for determining a network path mapping at a NE utilizing an MDAS producer according to an embodiment of the disclosure;

FIG. 10 illustrates a graph depicting neighbor nodes of a software-upgraded node according to an embodiment of the disclosure;

FIG. 11A illustrates a graph depicting a functionality validation of an average user equipment (UE) downlink (DL) throughput, sampled at a gNodeB (gNB), according to an embodiment of the disclosure;

FIG. 11B illustrates a graph depicting a functionality validation of a number of quality of service (QoS) flows successfully created, and sampled at an SMF, according to an embodiment of the disclosure;

FIG. 11C illustrates a graph depicting a stability validation of RAM usage, sampled at a virtual network function (VNF), according to an embodiment of the disclosure; and

FIG. 11D illustrates a graph depicting stability validation of CPU usage, sampled at a VNF, according to an embodiment of the disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In various examples of the disclosure described below, a hardware approach will be described as an example. However, since various embodiments of the disclosure may include a technology that utilizes both the hardware-based and the software-based approaches, they are not intended to exclude the software-based approach.

As used herein, the terms referring to merging (e.g., merging, grouping, combination, aggregation, joint, integration, unifying), the terms referring to signals (e.g., packet, message, signal, information, signaling), the terms referring to resources (e.g., section, symbol, slot, subframe, radio frame, subcarrier, resource element (RE), resource block (RB), bandwidth part (BWP), opportunity), the terms used to refer to any operation state (e.g., step, operation, procedure), the terms referring to data (e.g., packet, message, user stream, information, bit, symbol, codeword), the terms referring to a channel, the terms referring to a network entity (e.g., distributed unit (DU), radio unit (RU), central unit (CU), control plane (CU-CP), user plane (CU-UP), open radio access network (O-RAN) DU (O-DU), O-RAN RU (O-RU), O-RAN CU (O-CU), O-RAN CU-CP (O-CU-UP ( ), O-RAN CU-CP (O-CU-CP)), the terms referring to the components of an apparatus or device, or the like are only illustrated for convenience of description in the disclosure. Therefore, the disclosure is not limited to those terms described below, and other terms having the same or equivalent technical meaning may be used therefor. Further, as used herein, the terms, such as ‘˜ module’, ‘˜ unit’, ‘˜ part’, ‘˜ body’, or the like may refer to at least one shape of structure or a unit for processing a certain function.

Further, throughout the disclosure, an expression, such as e.g., ‘above’ or ‘below’ may be used to determine whether a specific condition is satisfied or fulfilled, but it is merely of a description for expressing an example and is not intended to exclude the meaning of ‘more than or equal to’ or ‘less than or equal to’. A condition described as ‘more than or equal to’ may be replaced with an expression, such as ‘above’, a condition described as ‘less than or equal to’ may be replaced with an expression, such as ‘below’, and a condition described as ‘more than or equal to and below’ may be replaced with ‘above and less than or equal to’, respectively. Furthermore, hereinafter, ‘A’ to ‘B’ means at least one of the elements from A (including A) to B (including B). Hereinafter, ‘C’ and/or ‘D’ means including at least one of ‘C’ or ‘D’, that is, {′C′, ‘D’, or ‘C’ and ‘D’}.

The disclosure describes various embodiments using terms used in some communication standards (e.g., 3rd generation partnership project (3GPP), extensible radio access network (xRAN), open-radio access network (O-RAN) or the like), but it is only of an example for explanation, and the various embodiments of the disclosure may be easily modified even in other communication systems and applied thereto.

For the purpose of promoting an understanding of the principles of the disclosure, reference will now be made to the various embodiments and specific language will be used to describe the same. It will nevertheless be understood that no limitation of the scope of the disclosure is thereby intended, such alterations and further modifications in the illustrated system, and such further applications of the principles of the disclosure as illustrated therein being contemplated as would normally occur to one skilled in the art to which the disclosure relates.

It will be understood by those skilled in the art that the foregoing general description and the following detailed description are explanatory of the disclosure and are not intended to be restrictive thereof.

Whether or not a certain feature or element was limited to being used only once, it may still be referred to as “one or more features” or “one or more elements” or “at least one feature” or “at least one element.” Furthermore, the use of the terms “one or more” or “at least one” feature or element does not preclude there being none of that feature or element, unless otherwise specified by limiting language including, but not limited to, “there needs to be one or more . . . ” or “one or more elements is required.”

Reference is made herein to some “embodiments.” It should be understood that an embodiment is an example of a possible implementation of any features and/or elements of the disclosure. Some embodiments have been described for the purpose of explaining one or more of the potential ways in which the specific features and/or elements of the proposed disclosure fulfil the requirements of uniqueness, utility, and non-obviousness.

Use of the phrases and/or terms including, but not limited to, “a first embodiment,” “a further embodiment,” “an alternate embodiment,” “one embodiment,” “an embodiment,” “multiple embodiments,” “some embodiments,” “other embodiments,” “further embodiment”, “furthermore embodiment”, “additional embodiment” or other variants thereof do not necessarily refer to the same embodiments. Unless otherwise specified, one or more particular features and/or elements described in connection with one or more embodiments may be found in one embodiment, or may be found in more than one embodiment of the disclosure, or may be found in all embodiments, or may be found in no embodiments. Although one or more features and/or elements may be described herein in the context of only a single embodiment of the disclosure, or in the context of more than one embodiment of the disclosure, or in the context of all embodiments, the features and/or elements may instead be provided separately or in any appropriate combination or not at all. Conversely, any features and/or elements described in the context of separate embodiments may alternatively be realized as existing together in the context of a single embodiment.

Any particular and all details set forth herein are used in the context of some embodiments and therefore should not necessarily be taken as limiting factors to the proposed disclosure.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Embodiments of the disclosure will be described below with reference to the accompanying drawings.

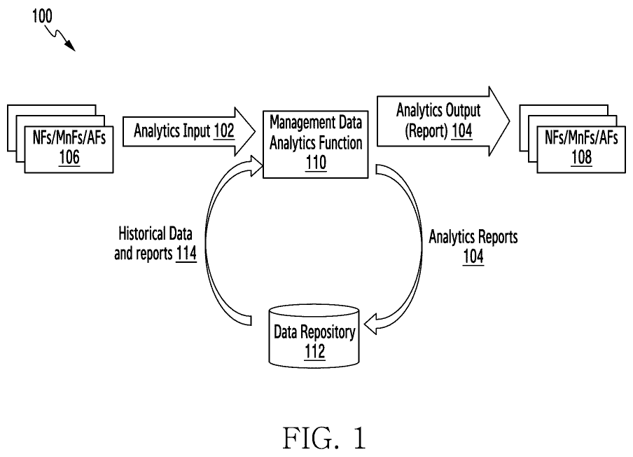

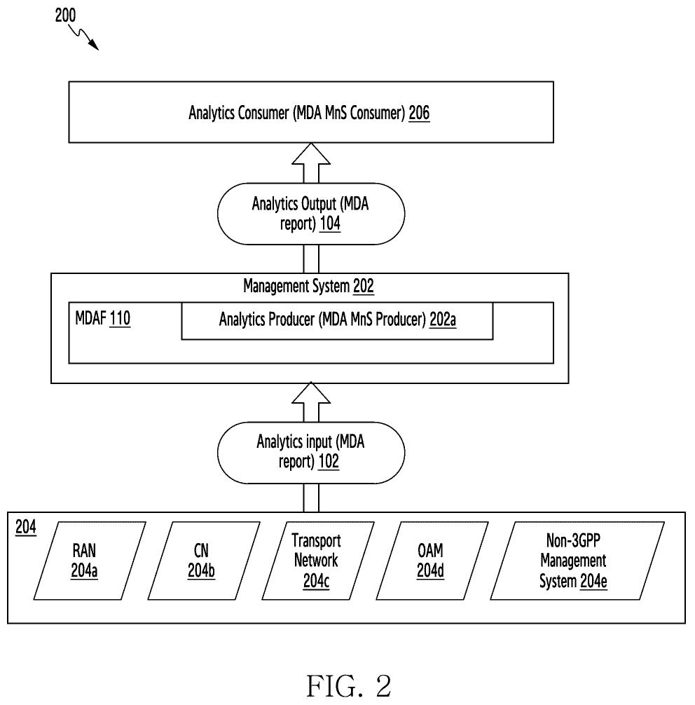

For the sake of clarity, the first digit of a reference numeral of each component of the disclosure is indicative of the figure number, in which the corresponding component is shown. For example, reference numerals starting with digit “1” are shown at least in FIG. 1. Similarly, reference numerals starting with digit “2” are shown at least in FIG. 2.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

FIG. 1 illustrates a high-level MDA architecture according to the related art.

Referring to FIG. 1, basic concepts and definitions for the MDA feature are initially introduced in the Rel-15, establishing a basis for more extensive research. This effort continued with a study during Release 17 (Rel-17), which culminated in successfully completing the normative work for the MDA feature in the Rel-17, providing key standards for future network management.

An MDA architecture 100 may be developed by the normative phase to address a wide range of use cases (capabilities), relevant requirements, and solutions with an analytics input (i.e., analytics enabling data) 102 and an analytics output (i.e., an analysis report) 104. The MDA architecture 100 further illustrates an MDA function 110 to support interactions between a service consumer 108 and a service producer 106 for MDA request and reporting. The analytics input 102 may be provided by the service producer 106 including, network functions (NFs), management network functions (MnFs), or application functions (AFs). The analytics output 104 may be provided to the service consumer 108 including, various NFs, MnFs, or AFs. The MDA function 110 utilizes a collection of current and historical management and network data to perform analytics that further enrich and enhance management capabilities to achieve an optimum network performance and service assurance. The current and historical management and network data may include information related to communication service, slicing, management, and/or network functions-related data. The MDA architecture 100 further includes a data repository (DR) 112. The MDA function 110 receives the analytics input 102 from the service producer 106 and retries historical data and reports 114 from the DR 112. The MDA function 110 then performs an analysis of the input data to generate the analytics output 104. Further, the MDA function 110 may provide the analytics output 104 to the DR 112. The analytics output 104 may include analytics reports. The DR 112 may be a centralized system used to collect, manage, and store data generated by the service producer 106 and the service consumer 108 in the network.

FIG. 2 illustrates a sequence flow of data 200 between various entities of an MDA architecture according to the related art.

Referring to FIG. 2, it illustrates a management system 202 that may include the MDA function (MDAF) 110. The MDAF 110 may include an analytic producer, or an MDA MnS producer (MDAS producer) 202a. The MDAS producer 202a may be responsible for generating the analytics output 104 by processing raw data related to network and service operations. The MDAS producer 202a collects data from network entities 204. The network entities 204 may include a radio access network (RAN) 204a, a core network (CN) 204b, a transport network (TN) 204c, operations, administration, and maintenance (OAM) 204d, and non-3rd generation partnership project (3GPP) management system 204e. An MDA MsN consumer 206 may represent an entity receiving the analysis report 208 from the MDAS producer 202a. The MDAS consumer 206 uses the analytics output 104 provided to make informed decisions about network operations, such as resolving coverage problem analysis, failure event analysis, or mobility management analysis. The management system 202 may be combined with artificial intelligence (AI) or machine learning (ML) technologies to analyse the received analytics input 102 and generate the required analytics output 104.

Further, with technical advancements in current era, software-based applications are being utilized almost in every industrial domain. Due to ever evolving nature of technology, software upgrades are required very frequently for corresponding applications installed in electronic devices. After a software upgrade procedure in such electronic devices, a validation process is usually performed to validate system stability and functionality after a software upgrade procedure. The existing MDA architecture 100 may lack a comprehensive solution for validating the software upgrades in the network entities 204.

In general, a software upgrade validation process comprises a series of steps. Specifically, a network operation center (NOC) processes traffic statistics to detect a lean period and perform a software upgrade. Even though the software upgrade task is performed during the night (anticipating that as the lean period), a maintenance window span is large because it involves a series of pre-checks and post-checks. Such checks include a set of key process indexes defined by the NOC. Typically, the software upgrade takes weeks or more to roll out a new software upgrade for the complete network. Due to the shorter software upgrade release cycle, it has become a formidable task for the NOC to process huge bearer statistics data.

To summarize, the NOC manually records key performance indicators (KPIs) necessary for software upgrade validation before the upgrade. Next, the software upgrade is performed, and KPIs are fetched after the software upgrade. Further, the fetched KPIs are manually validated with the recorded KPIs before the upgrade. Upon successful validation, the software upgrade is declared successful. Otherwise, the software upgrade is typically rolled back. This implies continuously validating KPIs over an extended period. Additionally, in the post-pandemic era and due to seasonal events, such as soccer, Olympic games, or the like, a number of connected electronic devices may vary randomly during the manual upgrade time. As a result, there is a need for a procedure to validate software upgrade in a limited time to reduce an impact of manually selected upgrade time by the NOC during aforementioned scenarios. Further, there is a need to replace the manual procedure with an automated framework to automate the entire software upgrade validation procedure.

Moreover, with the 5G new radio (NR), latency and reliability for critical applications such as factory automation, automation vehicles, remote control, and virtual/augmented reality may be warranted. However, for communication scenarios where the transmission involves a control plane (CP) and a user plane (UP), a delay in the CP and the UP setup contributes to an integral part of an end-to-end (E2E) latency. Further, any loss in data associated with the CP and the UP will inadvertently incur poor application experience for an end user. The E2E latency is an important parameter for ultra-reliable low-latency communication (URLLC) services. In particular, user data packets should be successfully delivered within certain time constraints to satisfy the end users' requirements. Latency may be impacted by network capability and network configurations. The network capability and network configuration factors may be a root cause if the latency requirements cannot be achieved. Further, latency related to packet transmission may dynamically change with a change in the network capability and network configuration. The latency requirement may be assured even if some of the network conditions may degrade.

The existing MDA architecture fails to reduce said latency and provide improved communication paths for data transmission.

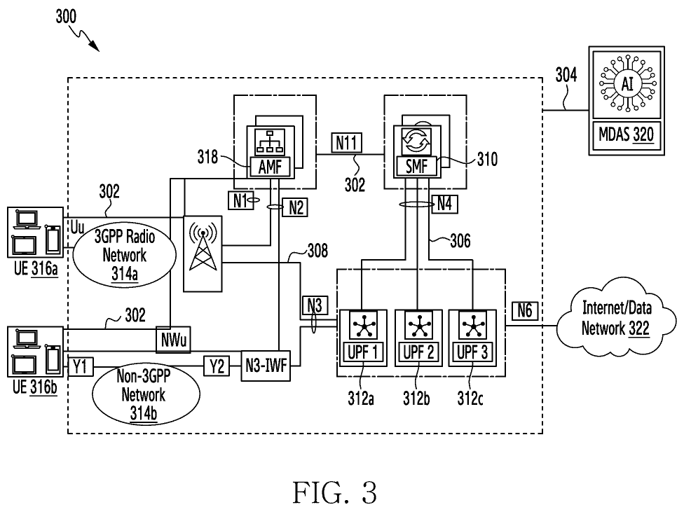

FIG. 3 illustrates a 5G Architecture with a point-to-point interface, according to the related art.

Referring to FIG. 3, a 5G architecture 300 may include a control plane path 302, a user plane path 306, and a management plane path 304. Further, a path is defined, wherein, the control plane is communicably coupled with the user plane path 306. The user plane path 306 may support communicating information between a session management function (SMF) 310 and a plurality of user plane functions (UPFs), i.e., UPF 1, UPF 2, and UPF 3 312a, 312b, and 312c. Similarly, an alternative path 308 is defined, where the user plane is communicably coupled with the user plane path 306. The alternative path 308 is configured to support communication between a third generation partnership Project (3GPP) radio network 314a and a non-3GPP network 314b to the plurality of UPFs 312a, 312b, and 312c. Moreover, the control plane path 302 is defined from a user equipment (UE) 316a or 316b to an access and mobility management function (AMF) 318 via the 3GPP radio network 310a and the non-3GPP network 310b. Furthermore, the management plane path 304 is defined when the 5G architecture is communicably coupled with an MDAS framework 320.

Additionally, the URLLC services may require each of the following conditions to be met: (a) a user plane latency which is less than Ims single way for downlink and uplink, and (b) a control plane latency that is less than 10 ms.

Further, a session establishment may involve an end-to-end path from the UE 316a or 316b to the MDAS framework 320 and an internet 322 adds complexity to achieving reliable and low-latency communication.

Therefore, in view of the above-mentioned problems, it is advantageous to provide an improved system and method that can overcome the above-mentioned problems and limitations associated with the MDAS framework.

Therefore, in view of the above-mentioned problems, it is advantageous to provide an improved system and method that can overcome the above-mentioned problems and limitations associated with the MDAS framework.

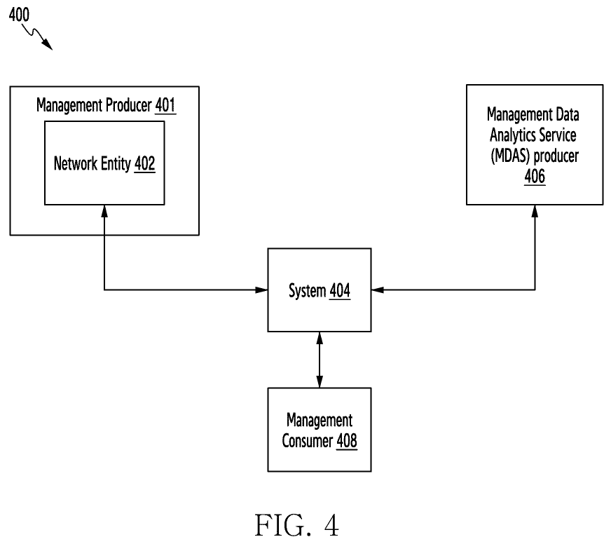

FIG. 4 illustrates a block diagram of a network environment for validation of software upgrades and optimization of network path mapping according to an embodiment of the disclosure.

Referring to FIG. 4, an environment 400 may include a management producer 401, a system 404, a management consumer 408, and a management data analytics service (MDAS) producer 406. The management producer 401 may include a network entity (NE) 402. The system 404 may either be implemented by the management producer 401 or the management consumer 408, as required. The system 404 may also be located remotely and communicably coupled with the management producer 401. The management consumer 408 may include various network functions, applications, or external systems that rely on analytics insights, key performance indicators (KPI), fault data, performance reports, or configuration updates to make informed decisions about network optimization, service orchestration, fault recovery, or capacity planning.

In an embodiment of the disclosure, the system 404 may be configured to perform validation of a software upgrade at the NE 402 utilizing the MDAS producer 406. In another embodiment of the disclosure, the system 404 may be configured to determine the network path mapping at the NE 402 utilizing the MDAS producer 406. The NE 402 may correspond to a radio access network (RAN) node.

In an embodiment of the disclosure, the system 404 may reside in a server and may be in communication with the NE 402. In another embodiment of the disclosure, the system 404 may be a part of the NE 402. The system 404 may include machine learning (ML) models. The ML models may include, but are not limited to, time series models (for example, a Holt-winter model, auto regressive integrated moving average (ARIMA) model, and the like.

The MDAS producer 406 may be configured to optimize a procedure of software upgrade at the NE 402 by providing a time frame to execute the required software upgrade with minimum expected impact. The software upgrade may be automatically initiated by an operations, administration, and maintenance (OAM) system (not shown), once configured, during the time frame when the expected impacts are minimal i.e., at an optimal time when there would be minimum expected operational cost and data loss. The optimal time (current or futuristic) may be derived by collecting and analyzing the data related to data radio bearers (DRBs) including guaranteed bit rate (GBR) or non-GBR, state, modification count, ongoing handover, and the like. The MDAS producer 406 may be configured to utilize historical data and the ML models to derive the future optimal time frame for the software upgrade. In an embodiment of the disclosure, the MDA producer 406 may be combined with artificial intelligence (AI) or ML technologies, which bring intelligence and automation to improve network service management and coordination.

In an embodiment of the disclosure, the system 404 may be configured to predict a first set of KPIs required to perform validation of the software upgrade. The ML models may be used to predict the first set of KPIs. The first set of KPIs may include, but are not limited to, functionality-related KPIs, resource-usage-related KPIs, and the like. The first KPIs or a second set of KPIs may include access and core statistics of the NE 402. The access and core statistics may include network function (NF) associated KPIs. The NF may include, but is not limited to, a new radio (NR) cell user plane (NR cell UP), an NR cell control plane (NR cell CP), an access and mobility management function (AMF), a session management function (SMF), user plane function (UPF), unified data management (UDM), policy control function (PCF), and the like. The functionality-related KPIs may include, but are not limited to, handover success rate (HOSR), dropped call rate (DCR), blocking probability (BP), and packet delay variation (PDV). Further, the resource-usage-related KPIs may include resource management KPIs. The resource management KPIs may include system power, temperature, and hardware resource usage.

In an example, the functionality-related KPI information and the resource-usage-related KPI information may be stored and processed at respective NF. The system 404 may be used to train the first set of KPIs and predict the context information at the NF to automate the software upgrade validation process. The system 404 may be configured to retain software upgrade duration at an orchestrator and predict the upgradation validation time to mitigate a stability issue of the NF and improve the reliability of the software upgrade. The validation time may include, but is not limited to, restoration time, and the like.

The NE 402 may perform the software upgrade. Further, the system 404 may be configured to determine a second set of KPIs associated with the NE 402 after performing the software upgrade at the NE 402. The second set of KPIs may be similar to the first set of KPIs, however, the set of KPIs is determined after performing the software upgrade. Furthermore, the system 404 may be configured to compare the predicted first set of KPIs and the determined second set of KPIs. In addition, the system 404 may be configured to validate the software upgrade at the NE 402 based on the comparison. A successful validation may correspond to an indicative prediction of a successful software upgrade at the NE 402 for a future point of time. In response to an unsuccessful validation, the system 404 may be configured to determine a node Identifier (ID) of a neighboring NE to offload traffic associated with the NE 402.

In another embodiment of the disclosure, the system 404 may be configured to determine the network path mapping at the NE 402 utilizing the MDAS producer 406. Further, the system 404 may be configured to receive network traffic information indicating network performance metrics for network traffic of network paths on a network. The network performance metrics may include, but are not limited to, a round trip time, packet loss, latency, and the like. Furthermore, the system 404 may be configured to predict a plurality of KPIs based on received network traffic information. In an embodiment of the disclosure, the system 404 may be configured to assign control plane traffic and user plane traffic according to a QoS Flow Identifier (QFI) value of service based on the predicted KPIs.

The ML models may be used to predict the plurality of KPIs. The plurality of KPIs may include, but are not limited to, a data network (DN) identifier (ID) of the NE, average round trip delay, an incoming general packet radio service (GPRS) tunnelling protocol (GTP) packet loss, an outgoing GTP packet loss, a reliability, an incoming representational state transfer (REST) packet loss, and outgoing REST packet loss, and the like.

In an embodiment of the disclosure, the NF may be configured to provide access, core KPI information, and resource uptime KPI information to the MDA producer 406. The NF may be identified as an instance identifier to be provided to the MDAS producer 406. The access and core KPI information and system KPI information may be periodically synchronized with the MDAS producer 406. A frequency of synchronization may be dynamically selected as per deployed network size.

In addition, the system 404 may be configured to determine optimal network paths based on the predicted plurality of KPIs. The optimal network paths may include, but are not limited to, control plane paths, plane paths, end-to-end (EtE) paths, and the like. Further, the system 404 may be configured to monitor the assigned control plane traffic and the user plane traffic along the determined optimal network paths for one upgradation and degradation in a network performance.

Further, the system 404 may be configured to generate a dataset of determined optimal network paths and the received network traffic information to manage the processing load at the NE 402. For example, the NF and associated parameters may influence the automated network topology mapping. The network topology mapping may be essential to align with service level agreements (SLAs) of each service. The SLAs may be defined by a 5G quality of experience framework indicator (5QFI). The dataset of determined optimal network paths may be accessible at the MDAS producer 406. In scenarios, where specific datasets for a particular service may not be synchronized or available, the system 404 may trigger appropriate alarms (e.g., “missing data”) to notify a relevant data provider, typically the network functions responsible for delivering that data. This proactive approach may ensure timely identification and rectification of data gaps, facilitating reliable network management and service delivery. Further, the system 404 may retrieve declared alarm information such as declared time, alarm group, probable cause, severity detailed alarm type threshold value, and location. The cleared alarm or the alarm whose inhibition status is set to inhibit may not be retrieved.

Before utilizing the dataset of determined optimal network paths for the ML models, the system 404 may perform a stationary check. The dataset may be classified as a stationary dataset or a non-stationary dataset. The dataset may include statistical properties (such as mean and variance) that may not change over time. The statistical properties may be crucial for the effectiveness of the ML models. The stationary check may involve evaluating the dataset of determined optimal network paths to determine if the dataset of determined optimal network paths exhibits a consistent pattern. If the dataset of determined optimal network paths is found to be stationary, the dataset of determined optimal network paths may be subjected to the ML Model for further analysis and predictions, enabling effective decision-making based on historical data trends. Conversely, if the dataset of determined optimal network paths is deemed the non-stationary, the procedure may require a waiting period to collect additional data. The process may involve repeating the stationary check until a satisfactory dataset is acquired. In the system 404, a partial correlation function (PCF) may be used to perform the stationary check. The PCF may be configured to identify the correlation between observations in the dataset of determined optimal network paths while controlling for the influence of other observations.

In an example, the dataset of determined optimal network paths may be modelled using the ML models to predict the optimal paths from control plane(s), and user plane(s) with the predicted KPIs with the timestamp. The system 404 may be configured to provide a list of paths per differentiated services code point with appropriate network functions periodically as a recommendation.

In an embodiment of the disclosure, the MDAS producer 406 may play a crucial role in ensuring that the NFs meet respective SLAs by analyzing the recommendations. When the NFs adhere to recommendations, the NFs may indicate that the SLAs are being met effectively. If the NF fails to meet the SLA based on the recommendations provided by the MDAS producer 406, the system 404 may undergo a reinforcement training. The reinforcement training may involve enhancing analytical capabilities and deriving alternate network topology mapping. Further, the reinforcement training may involve improving data synchronization frequency and adding new instances of the NFs into analytics calculations.

To maintain a stability of the MDAS producer 406 amid potentially large volumes of data, it is essential to retain the plurality of optimal paths and sub-optimal paths as per service requests. Selective retention may mitigate risks associated with data overload, ensuring that the system 404 operates efficiently without compromising performance. In scenarios where the service becomes stale, the implementation may opt to stale out certain entries from the dataset. This process involves removing outdated or irrelevant data points, thereby streamlining the analytics process and maintaining the relevance of the remaining data.

The MDAS producer 406 may be configured to analyze the network performance metrics to support service-level specifications (SLS) assurance. The SLS assurance may include service experience analysis, network slice throughput analysis, network slice traffic prediction, and end-to-end latency analysis.

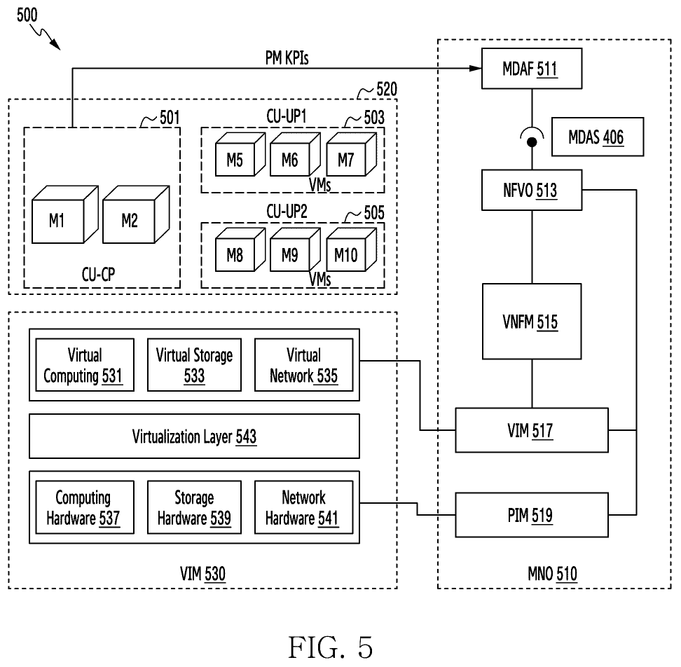

FIG. 5 illustrates components of a software upgrade validation framework of a 5G radio access network (RAN) node according to an embodiment of the disclosure.

Referring to FIG. 5, a software upgrade validation framework 500 may include a management and network orchestration (MNO) 510, a virtualized KPI entity 520, and a virtualized inventory management (VIM) 530. A CU-CP 501, CU-CPs 503, and 505 may be implemented as the virtualized Entity 520, which may be scaled independently based on traffic volume. The CU-CP 501 may include blocks M1 and M2. The block M1 may indicate a performance management PM KPI aggregator and a sender, emphasizing a role of aggregating and transmitting performance metrics.

Further, the block M2 may indicate one or more radio resource control (RRC) blocks, covering control plan signaling modules involved in managing radio resources and connection. The virtualized Entity 520 may run on virtual machines (VMs) and perform specific functions of 5G RAN CU and 5G RAN DU nodes. Therefore, the virtualized Entity 520 may be considered as the virtual RAN CU node.

In an example, consider that the virtualized Entity 520 performing the networking functions of CU-CP 501 is running on the block M-1 and the block M-2. Consider that the CU-UP is split into CU-UP1 503 and CU-UP2 505. The virtualized Entity 520 performing the networking functions of CU-UP1 503 is running on the blocks M-5, M-6, and M-7. The virtualized Entity 520 performing the networking functions of CU-UP2 505 is running on the blocks M-8, M-9, and M-10. The networking functions of the CU-CP 501 and the CU-UP 503, 505 are installed by loading the virtualized Entity 520 performing specific networking functions on the VMs. Therefore, the virtualized Entity 520 corresponding to the networking functions of the CU-CP 501 is upgraded during the CU-CP software upgrade.

The MNO 510 may include a MDAF 511, a network function virtualization (NFV) orchestrator (NFVO) 513, a virtualized network function manager (VNFM) 515, a virtualized infrastructure manager (VIM) 517, and a physical infrastructure manager (PIM) 519. A virtualized system manager (VSM) (not shown) provides management functions for operating and maintaining the RAN Node-CU and the RAN Node-DU. The PM KPIs may be aggregated and transmitted from the CU-CP 501 to the MDAF 511. The MDAF 511 may process the collected PM KPIs for further analysis, applying the ML models to predict future network performance.

The NFVO 513 may be responsible for the orchestration and management of virtualized resources in the network. In this context, the NFVO 513 may act as an MDAS consumer, leveraging the data analytics service for resource management decisions. The NFVO 513 may ensure that the required resources (e.g., computing, storage, network) are efficiently allocated to virtual network functions (VNFs) and manage the lifecycle of network services. The MDAS producer 406 may provide a software validation analytics report (SVAR) to the NFVO 513 as per subscription.

The VNFM 515 may be responsible for the lifecycle management of VNFs. The VNFM 515 handles the instantiation, scaling, updating, and termination of VNFs. The VNFM 515 may ensure that the VNFs operate within the parameters defined by the service provider, including monitoring and scaling resources as necessary.

The VIM 517 may be tasked with managing physical and virtual infrastructure (e.g., servers, storage, network devices) that underpins the virtualized network. The VIM 517 may handle the allocation of resources to virtual machines and virtual functions and ensure that virtual resources are mapped to physical hardware effectively.

The PIM 519 may refer to the component responsible for managing the physical infrastructure resources of the network, such as hardware devices, servers, storage, and network equipment. The PIM 519 may ensure that the physical infrastructure is properly maintained, monitored, and configured to support the virtualized functions and services running on top of the virtualized functions. The MDAS producer 406 may be a service that provides real-time analytics and reports related to the network and service management, specifically focusing on software upgrade validation. For example, the MDAS producer 406 gathers, processes, and analyzes raw performance data, generating insights into the success or failure of software upgrades. The MDAS producer 406 may assist in making decisions regarding future network upgrades by providing detailed validation analytics.

The VIM 517 may be configured to manage the virtual resources of the VIM 530, e.g., virtual computing 531, virtual storage 533, and virtual network 535. The PIM 519 may be configured to manage the hardware resources of the VIM 530, e.g., computing hardware 537, storage hardware 539, and network hardware 541. Further, the VIM 530 may include a virtualization layer.

The computing hardware 537 may be a physical component responsible for processing tasks and running software applications. The computing hardware 537 may include processors (CPUs), memory (RAM), and other related components that provide the computational power necessary for executing operations. The storage hardware 539 may represent physical devices used to store data. The storage hardware 539 may include hard drives, solid-state drives (SSDs), and other storage media that hold data, software, and system files, ensuring data persistence and accessibility. The network hardware 541 may refer to a physical infrastructure that facilitates communication and data exchange between devices within the network. The network hardware 541 may include routers, switches, network interface cards (NICs), and other components essential for networking and connectivity. The virtualization layer 543 may refer to a software layer that abstracts physical hardware resources (computing, storage, and networking) into virtualized components. The virtualization layer 543 enables the creation of virtual machines (VMs) and other virtualized resources, allowing for efficient and flexible management of hardware resources across the network.

In one or more embodiments of the disclosure, the NE 402 may be configured to send a validation analytics request of the NE 402 to the MDAS producer 406 through the system 404. Further, the NE 402 may be configured to receive a software validation analytics report (SVAR) in response to the validation analytics request of the NE 402. The NE 402 may include data networks (DNs) of the node. The DNs of the node may include, but are not limited to, the NR Cell UP, the NR Cell CP), the AMF, the SMF, and the like. The validation analytics request may be provided as analytics scope. The analytics scope may include a futuristic time stamp (min validation time) for which the validation analytics is requested.

In some embodiments of the disclosure, the analytics scope may include a support qualifier. The support qualifier may be referred to as “M.” In some embodiments of the disclosure, the analytics scope may include corresponding properties may include:
type: Integer, multiplicity: 1,
isOrdered: N/A,
isUnique: N/A,
defaultValue: None,
isNullable: False.
Inputs for “SVAR”

As a non-limiting example, Table 1 below depicts monitoring activities required for target nodes undergoing the software upgrade:

TABLE 1

| NAME | DEFINITION |
|---|---|
| Managed | The managed entities set may specify a set of managed |
| Entities | entities like the gNB, the AMF, the SMF, and the like. The |
| Set and its | KPIs associated with the set of managed entities may be |
| related | monitored (on a timestamp basis) for generating SWAR to |
| KPIs | validate the functionality of upgraded NF. |
| | Example: |
| | gNB: Refer TS 28.552 Section 5.1, AMF: Refer TS 28.552 |
| | Section 5.2, SMF: Refer TS 28.552 Section 5.3 Etc. |
| | Note: As it is not an ideal case for an entire managed entity |
| | to be upgraded at once, an operator may choose to |
| | selectively monitor the entity that is undergoing |
| | the software upgrade. |
| Virtual | Virtual resource usage may indicate the average variations |
| Resource | of virtual resource usage of the NF: The CPU, memory, |
| Usage | and storage before and after software upgrade (on |
| | a timestamp basis) (see definition in clause 7.1.9.2.3.2 of |
| | ETSI GS NFV-IFA 011 [26]) for the time duration as |
| | indicated by MinValidationTime attribute to validate the |
| | upgraded system stability. |
| GPRS | GPRS may specify the status information about the global |
| Status | positioning system (GPS), the GPS locking status (location, |
| | latitude, longitude, height) list of tracking satellites and |
| | Time of Day. |
| S1 Status | S1 status may specify the status information of an S1 |
| | interface. The S1 interface connects a mobility management |
| | entity (MME) with an eNB. The S1 interface exchanges the |
| | signals carrying the operation and management (OAM) |
| | information with the MME in order to support mobility of |
| | the UEs. Information retrieved by this command includes |
| | the MME ID stream control transmission protocol (SCTP) |
| | status and S1 interface status (S1AP_STATE) |
| X2 | X2 status may specify the status information of the X2 |
| STATUS | interface. The X2 interface provides a direct path of |
| | communication with the eNB of another cell existing in the |
| | system. The X2 interface is responsible for exchanging the |
| | signals required for fast handover load indicator info and |
| | the information required for self-optimization between |
| | eNBs. Information retrieved by this command includes the |
| | neighbor eNB ID stream control transmission protocol |
| | (SCTP) status (SCTP_STATE) and X2 interface status |
| | (X2AP_STATE). |
| SUBCELL | Subcell state/status may specify the operation status of a |
| STATE/ | subcell. It shows whether the cell is Enabled or Disabled for |
| STATUS | service and whether the cell is in an active state with active |
| | calls in a busy state with an inability to take any more calls |
| | or in an idle state with no active calls. |
| RRH | RRH status may specify the status information of a remote |
| STATUS | radio head (RRH). By entering the RRH information the |
| | RRH connection information operation status and firmware |
| | mode can be retrieved. |
| ACTIVE | Active alarms may specify the active alarm list in the |
| ALARMS | system 404. The active alarms may retrieve the declared |
| | alarm's information such as declared time, alarm group, |
| | probable cause, severity, detailed alarm type threshold |
| | value, and location. The cleared alarm or the alarm whose |
| | inhibition status is set to INHIBIT will not be retrieved. |
| HDLC | HDLC status may specify the high-level data link control |
| Status | (HDLC) interface information of the antenna line device |
| | (ALD). The operational status” device type HDLC |
| | address, connection status, and vendor of the ALD can be |
| | retrieved. |
| Remote | Remote electrical tilting information may specify the tilt |
| Electrical | information of the remote electrical tilting (RET) which is |
| Tilting | an antenna control device interfacing with the RRH. The |
| Information | RET location can be specified to retrieve the antenna tilt, or |
| | all the RET information can be retrieved without specifying |
| | the location. Tilt refers to the vertical angle of the antenna |
| | connected to the RET. |

As a non-limiting example, Table 2 below depicts the monitoring activities required for neighbouring instances of target node:

TABLE 2

| NAME | DEFINITION |
|---|---|
| Intra Frequency | An intra-frequency neighbour may specify |
| Neighbour | the number of intra-frequency neighbours |
| Inter Frequency | An inter-frequency Neighbour may specify |
| Neighbour | the number of intra-frequency neighbours |
| Handover Event | Handover event Autonomous neighbour may |
| Autonomous Neighbour | specify the number of neighbours added |
| | by HO event based Autonomous Neighbour. |
| Scheduled Autonomous | Scheduled autonomous neighbour may |
| Neighbour | specify the number of neighbours added |
| | by Scheduled Autonomous Neighbour. |
| TotX2Nbr | TotX2Nbr may specify the total number of |
| | X2 neighbours |
| InterVendorX2Nbr | InterVendorX2Nbr may specify the number |
| | of inter-vendor X2 neighbours |
| X2NbrWithNoX2 | X2NbrWithNoX2 may specify the number of |
| | X2 neighbours with X2 Handover disabled. |
| X2NbrWithNoVendorInfo | X2NbrwithNo Vendor info may specify the |
| | total number of X2 neighbours of which |
| | vendor information is not identified. |

The below Table 3 depicts Output of “SVAR”

TABLE 3

| NAME | DEFINITION |
|---|---|
| SVAR | The MDAS producer 406 may provide the SVAR |
| | information for the NE 402. The SVAR information may |
| | include: |
| | UpgradeStatus: This indicates if the upgrade should be |
| | considered successful for a future point in time (indicated in |
| | the request). This will be a Boolean attribute with a default |
| | value of TRUE. The value FALSE indicates the |
| | unsuccessful upgrade. |
| | (2) FailoverNode: In case of an unsuccessful upgrade the |
| | MDAS will also provide the DN of the node which may |
| | take over the traffic from the target node. Alternatively, this |
| | information can also be provided as part of the |
| | recommendation in the SVAR. |

In an embodiment of the disclosure, the MDAS producer 406 may provide the SVAR based on the input parameters. The SVAR may include upgrade status and failover node. The upgrade status may include a Boolean attribute indicating one of the successful software upgrade and an unsuccessful software. The Boolean attribute with a default value of TRUE may indicate the successful upgrade and the value FALSE may indicate the unsuccessful upgrade. Further, the SVAR may include a fail-over node. In case of an unsuccessful upgrade, the MDAS producer 406 may provide the DN of the node which may take over the traffic from the target node. Alternatively, the information may be provided as part of the recommendation in the SVAR. The software upgrade, whether successful or a failure, may be determined based on the following criteria. The confidence degree accuracy may be assessed for two key areas, functional validation, which compares the forecasted versus the actual PM KPIs of the NE 402 that underwent the software upgrade, and stability validation, which compares the predicted versus the actual software upgrade time, including system restoration. Both validation steps are to be completed within the minimum validation time, under the term “Min Validation Time.”

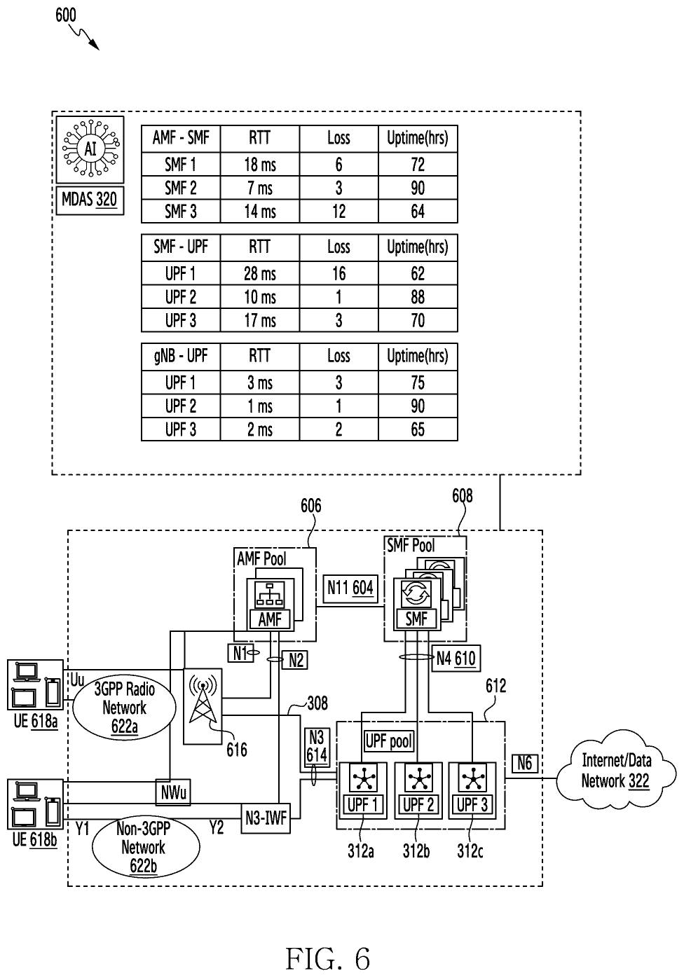

FIG. 6 illustrates a 5G architecture 600 for network topology mapping according to an embodiment of the disclosure.

Referring to FIG. 6, a 5G architecture 600 may include the MDAS framework 602 which collects on a management plane in order to perform heuristics learning on a plurality of parameters. The plurality of parameters may include a control plane (CP) which is an N11 interface 604 communicably connecting an AMF pool 606 with an SMF pool 608 in order to estimate the round trip time (RTT) and the packet loss. Further, the CP may be connected with the UP wherein an N4 interface 610 communicably connects the SMF pool 608 and a UPF pool 612 in order to estimate the RTT and the packet loss. Further, the UPF pool 612 may be communicably connected with the UP. An N3 interface 614 may be communicably connected to a gNB 616. The UPF pool 612 may be configured to estimate the RTT and the packet loss. Moreover, the RTT and the packet loss may include a connection between the SMF pool 608 and a unified data management (UDM) in an N10 interface (not shown) for subscription data and a connection between the SMF pool 608 and a point coordination function (PCF) in an N7 interface (not shown) for policy rules. Further, the MDAS producer 406 may be configured to deploy the ML models to analyze the above parameters and subsequently choose the optimal path. In an embodiment of the disclosure, an alternative path may be configured to communicate from a third generation partnership project (3GPP) radio network 622a and a non-3GPP network 622b to the UPF pool 612. Moreover, the control plane path may be defined from a user equipment (UE) 618a or 618b to the AMF pool 606 via the 3GPP radio network 622a and the non-3GPP network 622b.

In an embodiment of the disclosure, the AMF pool 606 may include AMF 1, AMF 2, and AMF 3. Further, the SMF pool 608 may include SMF 1, SMF 2, and SMF 3. Further, UPF pool 612 may include UPF 1, UPF 2, and UPF 3. The MDAS framework 602 may include the optimal paths such as SMF 2 from AMF-SMF, UPF 2 from the SMF-UPF, and UPF 2 from the gNB-UPF. Further, a session establishment may involve an end-to-end path from the UE 618a or 618b to the MDAS framework 602 and a network 620 to achieve reliable and low-latency communication. As a non-limiting example, Table 4 below depicts the relevant KPIs of the use cases. Table 4 shows only the end-to-end latency and reliability of the KPIs, as per non-limiting examples.

TABLE 4

| | | |
|---|---|---|
| Scenario | End-end Latency | Reliability |

| | | | |
|---|---|---|---|
| Discrete automation- | 1 | ms | 99.9999% |
| motion control | | | |
| Electricity | 5 | ms | 99.9999% |
| distribution-high | | | |
| voltage | | | |
| Remote control | 5 | ms | 99.999% |
| Discrete automation | 10 | ms | 99.99% |
| Intelligent transport | 10 | ms | 99.9999% |
| systems-Infrastructure | | | |
| backhaul | | | |
| Process automation- | 50 | ms | 99.9999% |
| remote control | | | |
| Process automation- | 50 | ms | 99.9% |
| monitoring | | | |
| Electricity distribution | 25 | ms | 99.9% |

medium voltage

In one or more embodiments of the disclosure, the system 404 may be configured to send the predicted plurality of KPIs to the MDAS producer 406. Further, the system 404 may be configured to receive a network topology mapping report (NTMR) in response to sending the predicted plurality of KPIs. The NTMR may include an identifier of analytics, analytics output generation time, peer information, a peer identifier, a round-trip time, packet loss, reliability, and an interface type. MDA request for the NTMR is shown in Table 5 below.

TABLE 5

| | | Support | |
|---|---|---|---|
| Name | Definition | Qualifier | Properties |
| Analytics | The DN's | M | type: Integer, multiplicity: |
| Scope | (instance ID) of | | 1, is Ordered: N/A, isUnique: |
| | the entities for | | N/A, defaultValue: None, is |
| | which the NTMR | | Nullable: False |
| | is requested | | |

Details are now provided regarding input parameters for the NTMR. Regarding monitoring PM KPIs at the gNB 616 for available instances of Core UPF (the N3 interface 614), reference is made to Table 6 below.

TABLE 6

| Name | Definition |
|---|---|
| SourcevnfInstanceID | gNB Identifier of the source VNF Instance. |
| | 3GPP TS 28.527 discusses the life cycle |
| | management (LCM) stage 2 specification (the |
| | Ve-Vnfm-em interface) |
| Timestamp | Timestamp when the NTMR is generated |
| Avg. Round-Trip | Average round-trip delay measurement provides |
| Delay | the average round-trip delay on the N3 interface |
| | 614 of this gNB 616 on PDU Session Anchor |
| | (PSA) for available instances of the UPF pool |
| | 612. This measurement is split into sub-counters |
| | per DSCP (Differentiated Services Code Point) |
| | Already defined in section 5.4 of TS 28.552 |
| | Core UPF Instance Set {Core UPF ID 1 - Round |
| | Trip Delay, Core UPF ID 2 - Round Trip Delay, |
| | Core UPF ID N - Round Trip Delay} |
| IncomingGTPPac- | Incoming GTP Packet loss measurement |
| ketloss | provides the number of GTP data packets of this |
| | gNB 616 that are not successfully received at the |
| | UPF pool 612. It is a measure of the incoming |
| | GTP data packet loss per N3 614 on a UPF |
| | interface for available instances of core UPF |
| | pool 612. If a quality of service (QoS) level |
| | measurement is performed, the measurements |
| | are equal to the number of 5Qis. If the optional |
| | S-NSSAI sub-counter measurements are |
| | performed, the number of measurements is equal |
| | to the number of supported S-NSSAIs. Already |
| | defined in section 5.4 of TS 28.552. |
| | Core UPF Instance Set { |
| | Core UPF ID 1: Packet Loss Count, Core UPF |
| | ID 2: Packet Loss Count, . . . Core UPF ID N: |
| | Packet Loss Count |
| | } |
| OutgoingGTPPac- | Outgoing GTP Packet loss measurement may |
| ketloss | provide the number of GTP data packets of the |
| | gNB 616 that are not successfully received at |
| | gNB 616 over the N3 interface 614. It is a |
| | measure of the outgoing GTP data packet loss |
| | per the N3 interface 614 on the UPF interface. |
| | The measurement is split into subcounters per |
| | QoS level (5QI). Already defined in section 5.4 |
| | of TS 28.552. |
| | Core UPF Instance Set { |
| | Core UPF ID 1: Packet Loss Count, Core UPF |
| | ID 2: Packet Loss Count, Core UPF ID N: |
| | Packet Loss Count |
| | } |
| Reliability | Reliability measurement provides uptime for |
| | available Core UPF instances arranged in order |
| | from highest to lowest (associated projected |
| | Reliability Rank of these instances). |
| | Core UPF Instance Set { |
| | Core UPF ID 1: Uptime, Core UPF ID 2: |
| | Uptime, Core UPF ID N: Uptime |
| | } |

Regarding monitoring PM KPIs at the AMF pool 606 for available instances of the SMF pool 608 (N11 Interface) 604, reference is made to Table 7 below.

TABLE 7

| Name | Definition |
|---|---|
| SourcevnfInstanceID | An AMF Identifier of the source VNF Instance. |
| | 3GPP TS 28.527 discusses the life cycle |
| | management (LCM) stage 2 specification (the |
| | Ve-Vnfm-em interface) |
| Timestamp | Timestamp when the NTMR is generated |
| Avg. Round-Trip | Average round-trip delay measurement may |
| Delay | provide the average round-trip delay on an N11 |
| | interface of the AMF pool 606 for available |
| | instances of SMF pool 608. This measurement |
| | is split into sub-counters per DSCP |
| | (Differentiated Services Code Point) |
| | SMF Instance Set {SMF ID 1 - Round Trip |
| | Delay, SMF ID 2 - Round Trip Delay, SMF ID |
| | N - Round Trip Delay} |
| IncomingRESTPac- | Incoming REST packet loss measurement may |
| ketloss | provide the number of control packets that are |
| | not successfully received at this AMF pool 606. |
| | It is a measure of the incoming control packet |
| | loss per N11 for available instances of SMF |
| | pool 608. If the QoS level measurement is |
| | performed, the measurements are equal to the |
| | number of 5Qis. To be defined in TS 28.552 |
| | SMF Instance Set { |
| | SMF ID 1: Packet Loss Count, SMF ID 2: |
| | Packet Loss Count, . . . SMF ID N: Packet Loss |
| | Count |
| | } |
| OutgoingRESTPac- | Outgoing REST packet loss measurement may |
| ketloss | provide the number of control packets that are |
| | not successfully received at the AMF pool 606 |
| | over the N11 interface. It is a measure of the |
| | outgoing control packet loss per the N4 |
| | interface 610 on the SMF interface. The |
| | measurement is split into subcounters per QoS |
| | level (5QI). To be defined in TS 28.552 |
| | SMF Instance Set { |
| | SMF ID 1: Packet Loss Count, SMF ID 2: |
| | Packet Loss Count, SMF ID N: Packet Loss |
| | Count |
| | } |
| Reliability | Reliability measurement may provide uptime |
| | for available SMF instances arranged in order |
| | from highest to lowest (associated projected |
| | Reliability Rank of these instances). |
| | SMF Instance Set { |
| | SMF ID 1: Uptime, SMF ID 2: Uptime, SMF |
| | ID N: Uptime |
| | } |

Regarding monitoring PM KPIs at the SMF pool 608 for available instances of Core UPF pool 612 (N4 interface 610), reference is made to Table 8 below.

TABLE 8

| Name | Definition |
|---|---|
| SourcevnfInstanceID | An SMF identifier of the source VNF |
| | Instance. |
| | 3GPP TS 28.527 discusses the life cycle |
| | management (LCM) stage 2 specification |
| | (the Ve-Vnfm-em interface) |
| Timestamp | Timestamp when the NTMR is generated |
| Avg. Round-Trip | Average round-trip delay measurement |
| Delay | may provide the average round-trip delay |
| | on the N4 interface 610 of the SMF pool |
| | 608 for available instances of the UPF pool |
| | 612. This measurement is split into sub- |
| | counters per DSCP (Differentiated Services |
| | Code Point) |
| | Core UPF Instance Set {Core UPF ID 1 - |
| | Round Trip Delay, Core UPF - Round Trip |
| | Delay, Core UPF - Round Trip Delay} |
| IncomingRESTPacketloss | Incoming REST packet loss measurement |
| | may provide the number of control packets |
| | that are not successfully received at the |
| | SMF pool 608. It is a measure of the |
| | incoming control packet loss per N4 |
| | interface 610 for available instances of |
| | Core UPF pool 612. If the QoS level |
| | measurement is performed, the |
| | measurements are equal to the number of |
| | 5Qis. To be defined in TS 28.552 |
| | Core UPF Instance Set { |
| | Core UPF ID 1: Packet Loss count, Core |
| | UPF ID 2: Packet Loss Count, . . . Core UPF |
| | ID N: Packet Loss Count |
| | } |
| OutgoingRESTPacketloss | Outgoing REST packet loss measurement |
| | may provide the number of control packets |
| | that are not successfully received at this |
| | SMF pool 608 over the N4 interface 610. It |
| | is a measure of the outgoing control packet |
| | loss per the N4 interface 610 on the UPF |
| | interface. The measurement is split into |
| | subcounters per QoS level (5QI). To be |
| | defined in TS 28.552 |
| | Core UPF Instance Set { |
| | Core UPF ID 1: Packet Loss Count, Core |
| | UPF ID 2: Packet Loss Count, Core UPF |
| | ID N: Packet Loss Count} |
| Reliability | Reliability measurement may provide |
| | uptime for available Core UPF instances |
| | arranged in order from highest to lowest |
| | (associated projected Reliability Rank of |
| | these instances). |
| | Core UPF Instance Set { |
| | Core UPF ID 1: Uptime, Core UPF ID 2: |
| | Uptime, Core UPF ID N: Uptime |
| | } |

Regarding monitoring PM KPIs at the SMF pool 608 for available instances of UDM (N10 Interface), reference is made to Table 9 below.

TABLE 9

| Name | Definition |
|---|---|
| SourcevnfInstanceID | The SMF identifier of the source VNF |
| | Instance. |
| | 3GPP TS 28.527 discusses the life cycle |
| | management (LCM) stage 2 specification (the |
| | Ve-Vnfm-em interface) |
| Timestamp | Timestamp when the NTMR is generated |
| Avg. Round-Trip | Average round trip delay measurement may |
| Delay | provide the average round-trip delay on an |
| | N10 interface of the SMF pool 608 for |
| | available instances of UDM. |
| | UDM Instance Set {UDM ID 1 - Round Trip |
| | Delay, UDM - Round Trip Delay, UDM - |
| | Round Trip Delay} |
| IncomingRESTPac- | Incoming REST packet loss measurement |
| ketloss | may provide the number of control packets |
| | that are not successfully received at the SMF |
| | pool 608. It is a measure of the incoming |
| | control packet loss per N10 for available |
| | instances of UDM. To be defined in TS |
| | 28.552 |
| | UDM Instance Set { |
| | UDM ID 1: Packet Loss Count, UDM ID 2: |
| | Packet Loss Count, . . . UDM ID N: Packet |
| | Loss Count |
| | } |
| OutgoingRESTPac- | Outgoing REST packet loss measurement |
| ketloss | may provide the number of control packets |
| | that are not successfully received at the SMF |
| | pool 608 over the N10 interface. It is a |
| | measure of the outgoing control packet loss |
| | per the N10 interface on the UDM interface. |
| | To be defined in TS 28.552 |
| | UDM Instance Set { |
| | UDM ID 1: Packet Loss Count, UDM ID |
| | 2: Packet Loss Count, UDM ID N: Packet |
| | Loss Count |
| | } |
| Reliability | Reliability measurement may provide uptime |
| | for available UDM instances arranged in |
| | order from highest to lowest (associated |
| | projected Reliability Rank of these instances). |
| | Core UDM Instance Set { |
| | UDM ID 1: Uptime, UDM ID 2: Uptime, |
| | UDM ID N: Uptime |
| | } |

Regarding monitoring PM KPIs at the SMF pool 608 for available instances of PCF (N7 Interface), reference is made to Table 10 below.

TABLE 10

| Name | Definition |
|---|---|
| SourcevnfInstanceID | The SMF identifier of the source VNF |
| | Instance. |
| | 3GPP TS 28.527 discusses the life cycle |
| | management (LCM) stage 2 specification |
| | (the Ve-Vnfm-em interface) |
| Timestamp | Timestamp when the NTMR is generated |
| Avg. Round-Trip | The average round-trip delay measurement |
| Delay | may provide the average round-trip delay |
| | on the N7 interface of the SMF pool 608 |
| | for available instances of the PCF. |
| | PCF Instance Set {PCF ID 1 - Round Trip |
| | Delay, PCF - Round Trip Delay, PCF - |
| | Round Trip Delay} |
| IncomingRESTPacketloss | The incoming REST packet loss |
| | measurement may provide the number of |
| | control packets that are not successfully |
| | received at the SMF pool 608. It is a |
| | measure of the incoming control packet |
| | loss per N7 for available instances of PCF. |
| | To be defined in TS 28.552 |
| | PCF Instance Set { |
| | PCF ID 1: Packet Loss Count, PCF ID 2: |
| | Packet Loss Count, . . . PCF ID N: Packet |
| | Loss Count |
| | } |
| OutgoingRESTPacketloss | The outgoing REST packet loss |
| | measurement may provide the number of |
| | control packets that are not successfully |
| | received at the SMF pool 608 over the N7 |
| | interface. It is a measure of the outgoing |
| | control packet loss per the N7 interface on |
| | the PCF interface. To be defined in TS |
| | 28.552 |
| | PCF Instance Set { |
| | PCF ID 1: Packet Loss Count, PCF ID 2: |
| | Packet Loss Count, PCF ID N: Packet |
| | Loss Count |
| | } |
| Reliability | The reliability measurement may provide |
| | uptime for available PCF instances |
| | arranged in order from highest to lowest |
| | (associated projected Reliability Rank of |
| | these instances). |
| | PCF Instance Set { |
| | PCF ID 1: Uptime, PCF ID 2: Uptime, |
| | PCF ID N: Uptime |
| | } |

Regarding attributes of the NTMR, reference is made to Table 11 below.

TABLE 11

| Attribute | Description |
|---|---|
| analyticsId | The identifier of the analytics output. |
| analyticsOutputGener- | analyticsOutputGenerationTime indicates |
| ationTime | the time when the analytics output is |
| | generated. |
| PeerInfo | Peer information may provide the required |
| | information on various performance |
| | measurements pertaining to the neighbour |
| | nodes. |
| | For example: In the case of the N11 |
| | Interface - Peer Information may indicate |
| | AMF information. |
| >>peerIdentifier | The identification of a set of neighbour |
| | nodes for this peer. This may be a DN on the |
| | Managed Function. |
| | For example: In the case of the N11 |
| | Interface, a Set of SMF IDs are peer |
| | identifiers for the AMF pool 606 |
| >>RTT | Set of available instances for the peer for the |
| | NF as represented by PeerInfo and |
| | associated projected Round-Trip Time |
| | (RTT) of these instances. |
| | Set { |
| | Peeridentifier 1: RTT, Peeridentifier 2: |
| | RTT, Peeridentifier N: RTT |
| | } |
| >>packetLoss | Set of available instances for the peer for the |
| | NF as represented by PeerInfo and |
| | associated projected packet loss of these |
| | instances. |
| | Set { |
| | Peeridentifier 1: Pkt Loss(Ingress and |
| | Egress), |
| | Peeridentifier 2: Pkt loss (Ingress and |
| | Egress), |
| | Peeridentifier N: Pkt loss (Ingress and |
| | Egress) |
| | } |
| >>Reliability | Set of available instances for this peer for |
| | NF as represented by PeerInfo and |
| | associated projected Reliability Rank of |
| | these instances. |
| | Set { |
| | Peeridentifier 1, Peeridentifier 2, |
| | Peeridentifier N: |
| | } - Here Peeridentifier has higher priority |
| | than all other PeerIdentifiers |
| | Reliable (OR) Not Reliable [Based on |
| | heuristics, MDAS can determine whether the |
| | NF's have been built for reliability or over |
| | utilization] |
| >> Interface Type | N11 (OR) N4 (OR) N3 (OR) N10 (OR) N7 |

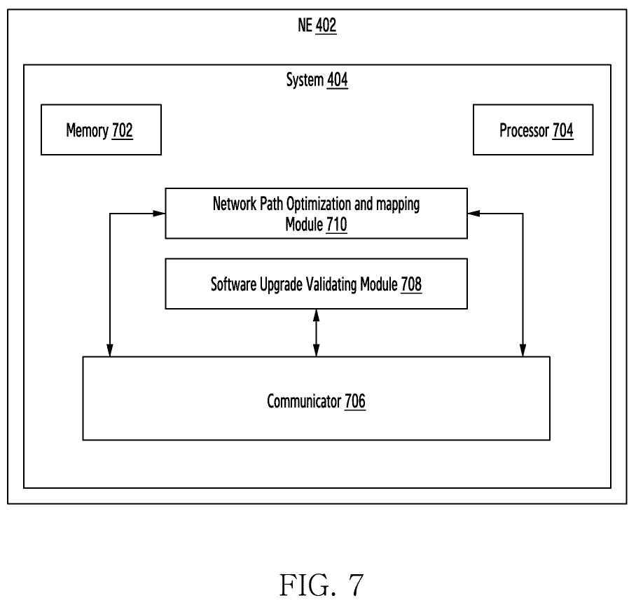

FIG. 7 illustrates a block diagram of a NE to validate software upgrades and optimize a network path mapping in a telecommunication network according to an embodiment of the disclosure. The NE 402 may refer to the RAN node.

Referring to FIG. 7, the NE 402 may include the system 404. The system 404 may be implemented on the NE 402 and may include memory 702, a processor 704, a communicator 706, and an NTN access management module 710.

In an embodiment of the disclosure, the memory 702 may store instructions to be executed by the processor 704 for software upgrade validation and the optimal network path, as discussed throughout the disclosure. The memory 702 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 702 may, in some examples, be considered a non-transitory storage medium. The term “non-transitory” may indicate that the storage medium is not embodied in a carrier wave or a propagated signal. However, the term “non-transitory” should not be interpreted that the memory 702 is non-movable. In some examples, the memory 702 can be configured to store larger amounts of information than the memory. In certain examples, a non-transitory storage medium may store data that can, over time, change (e.g., in random access memory (RAM) or cache). The memory 702 can be an internal storage unit, or it can be an external storage unit of the NE 402, a cloud storage, or any other type of external storage.

The processor 704 may communicate with the memory 702 and the communicator 706. The processor 704 is configured to execute instructions stored in the memory 702 and to perform various processes for NTN access management, as discussed throughout the disclosure. The processor 704 may include one or a plurality of processors, maybe a general-purpose processor, such as a central processing unit (CPU), an application processor (AP), or the like, a graphics-only processing unit, such as a graphics processing unit (GPU), a visual processing unit (VPU), and/or an artificial intelligence (AI) dedicated processor, such as a neural processing unit (NPU).

In one or more embodiments of the disclosure, the software upgrade validating module 708 and the network path optimization and mapping module 710 may be implemented by processing circuitry such as logic gates, integrated circuits, microprocessors, microcontrollers, memory circuits, passive electronic components, active electronic components, optical components, hardwired circuits, or the like, and may optionally be driven by firmware. The circuits may, for example, be embodied in one or more semiconductor chips, or on substrate supports such as printed circuit boards and the like. The software upgrade validating module 708 may perform one or more operations to validate the software upgrades, which are given below.

The software upgrade validating module 708 may be configured to predict the first set of KPIs required to perform validation of the software upgrade. Thereafter, the NE 402 may perform the software upgrade. Further, the software upgrade validating module 708 may be configured to determine the second set of KPIs associated with the NE 402 after performing the software upgrade at the NE 402. Furthermore, the software upgrade validating module 708 may be configured to compare the predicted first set of KPIs and the determined second set of KPIs. In addition, the software upgrade validating module 708 may be configured to validate the software upgrade at the NE 402 based on the comparison.

The network path optimization and mapping module 710 may perform one or more operations to determine the optimal network path, which is given below.

In one or more embodiments of the disclosure, the network path optimization and mapping module 710 may be configured to receive network traffic information indicating network performance metrics for network traffic of the network paths on the network. Further, the network path optimization and mapping module 710 may be configured to predict the plurality of KPIs based on the received network traffic information. Furthermore, the network path optimization and mapping module 710 may be configured to determine the optimal network paths based on the predicted plurality of KPIs.

The communicator 706 is configured for communicating internally between internal hardware components and with external devices (e.g., server) via one or more networks (e.g., radio technology). The communicator 706 may include an electronic circuit specific to a standard that enables wired or wireless communication.

Although FIG. 7 shows various hardware components of the NE 402, but it is to be understood that other embodiments are not limited thereon. In other embodiments of the disclosure, the NE 402 may include less or more number of components. Further, the labels or names of the components are used only for illustrative purposes and do not limit the scope of the disclosure. One or more components can be combined to perform the same or substantially similar functions to establish the formalized federation.

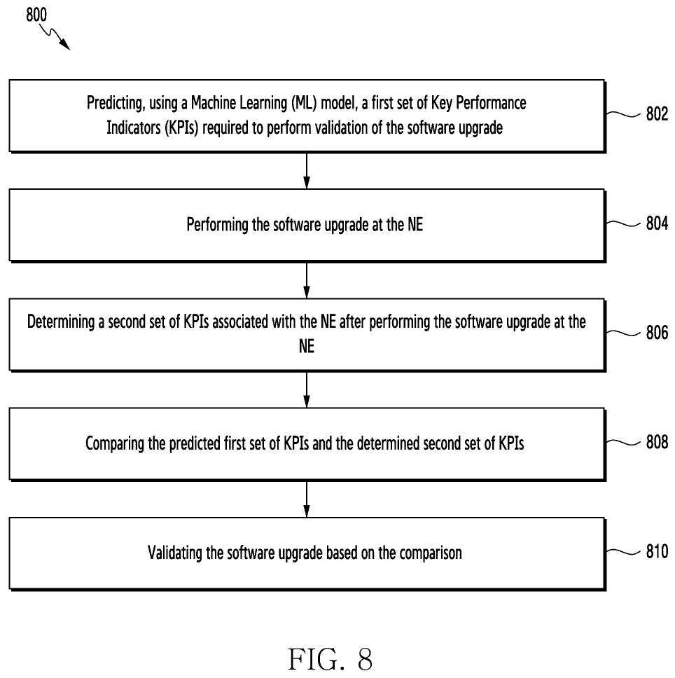

FIG. 8 is a flow diagram illustrating a method that includes operations associated with a NE for performing validation of the software upgrade utilizing an MDAS producer according to an embodiment of the disclosure.

Referring to FIG. 8, at operation 802, a method 800 may include predicting, using the ML model, the first set of KPIs required to perform validation of the software upgrade.

At operation 804, the method 800 may include performing the software upgrade at the NE 402.

At operation 806, the method 800 may include determining the second set of KPIs associated with the NE 402 after performing the software upgrade at the NE 402.

At operation 808, the method 800 may include comparing the predicted first set of KPIs and the determined second set of KPIs.

At operation 810, the method 800 may include validating the software upgrade based on the comparison.

In one or more operations, the method 800 may include the successful validation that corresponds to the indicative prediction of the successful software upgrade at the NE 402 for a future point of time. In a scenario, in response to the unsuccessful validation, the method 800 may include determining the node ID of a neighbouring NE to offload traffic associated with the NE 402. Further, the method 800 may include sending the validation analytics request of the NE 402 to the MDAS producer 406. Further, the method 800 may include receiving the SVAR in response to the validation analytics request of the NE 402. The SVAR may include the upgrade status. The upgrade status may include a Boolean attribute indicating one of the successful software upgrade and an unsuccessful software. Further, a description related to the various operations of FIG. 8 is covered in the description related to FIG. 4 and is omitted herein for the sake of brevity.

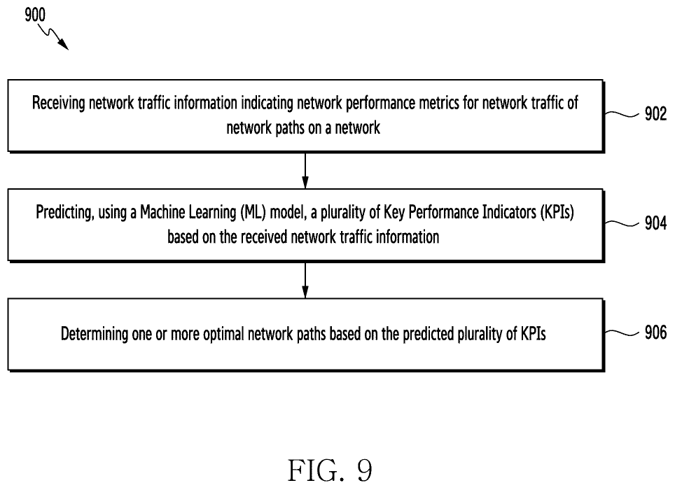

FIG. 9 is a flow diagram illustrating a method that includes operations associated with a NE for determining a network path mapping at a NE utilizing a MDAS producer according to an embodiment of the disclosure.

Referring to FIG. 9, at operation 902, a method 900 may include receiving network traffic information indicating network performance metrics for the network traffic of network paths on the network.

At operation 904, the method 900 may include predicting the plurality of key performance indicators (KPIs) based on the received network traffic information.

At operation 906, the method 900 may include determining the optimal network paths based on the predicted plurality of KPIs.

In one or more operations, the method 900 may include updating the pre-stored dataset of the plurality of KPIs based on the received network traffic information. Further, the method 900 may include generating the dataset of determined optimal network paths and the received network traffic information to manage processing load at the NE, wherein the one or optimal network paths comprises one or more control plane paths, one or more user plane paths, and end-to-end (E2E) paths. Furthermore, the method 900 may include sending the predicted plurality of KPIs to the MDAS producer 406. The predicted plurality of KPIs may include a DN ID of the NE 402, the average round trip delay, the GTP packet loss, the outgoing GTP packet loss, the reliability, the incoming REST packet loss, and the outgoing REST packet loss. In addition, the method 900 may include receiving the NTMR in response to sending the predicted plurality of KPIs. Further, the method 900 may include monitoring the predicted plurality of KPIs at the NE 402 for the optimal network paths.

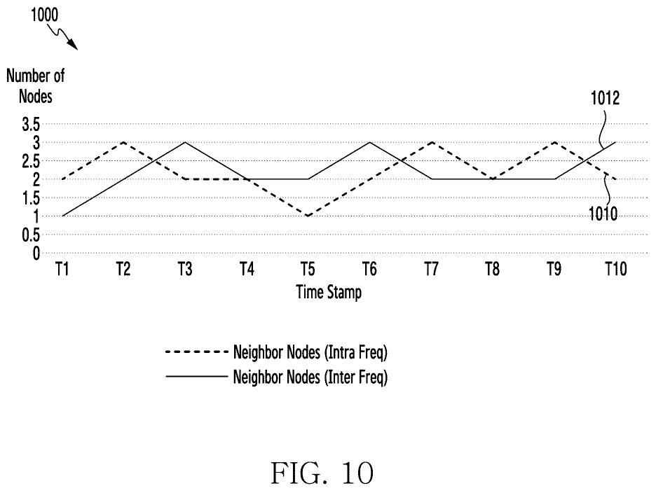

FIG. 10 illustrates a graph depicting neighbor nodes of a software-upgraded node according to an embodiment of the disclosure.

Referring to FIG. 10, a graph 1000 may include a X-axis representing the timestamp and a Y-axis representing the Neighbor Nodes. The example graph 1000 illustrates the interaction between intra-frequency neighbor nodes 1010 and inter-frequency neighbor nodes 1012 during the software upgrade process. The intra-frequency may refer to the neighboring nodes operating on the same frequency band as the upgraded node. Further, the inter-frequency may refer to neighboring nodes operating on different frequency bands.

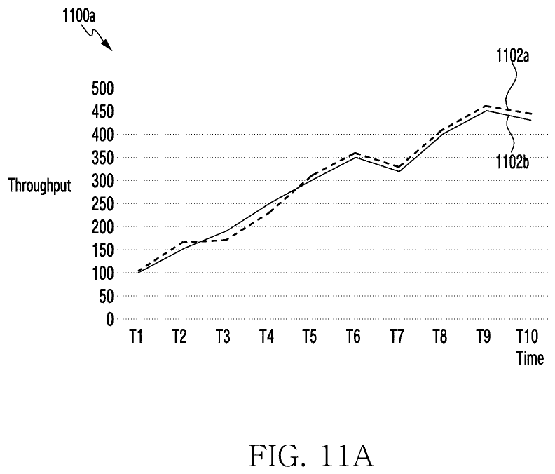

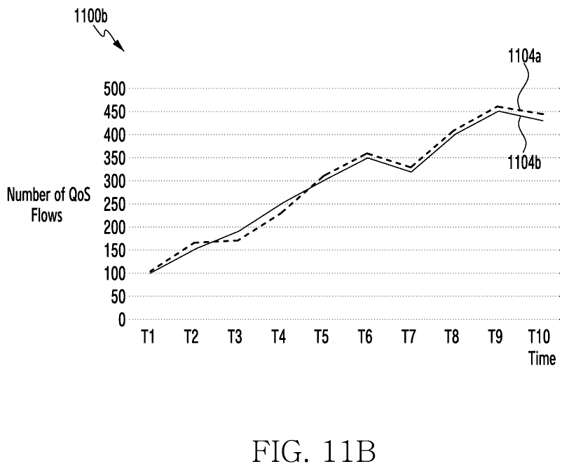

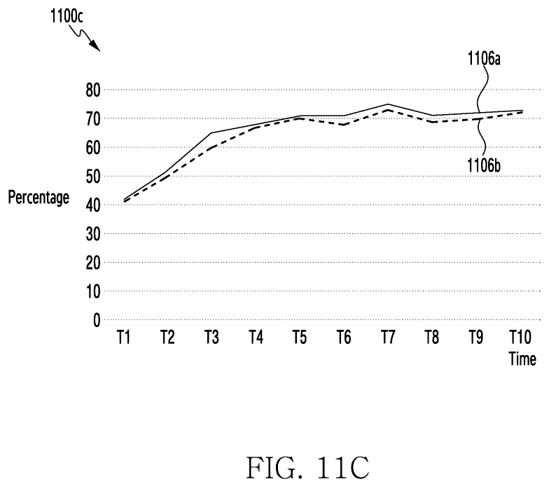

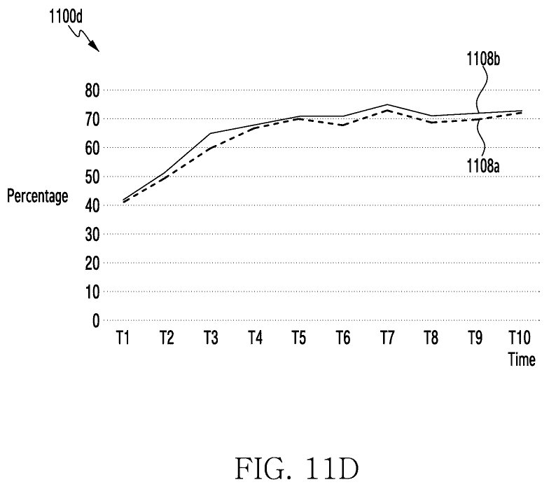

FIG. 11A illustrates a graph depicting a functionality validation of an average UE downlink (DL) throughput, sampled at a gNB according to an embodiment of the disclosure.

Referring to FIG. 11A, a graph 1100a may include the X-axis representing the actual values 1102a and predicted values 1102b over a timeline or set of events. The Y-axis represents the throughput. The throughput may be measured in Mbps or Gbps.

The graph 1100a may include the comparison of the actual DL throughput experienced by UE with the predicted throughput as forecasted by the ML model. The comparison helps assess the accuracy of throughput predictions and the performance of the gNB 616 in delivering expected downlink rates, validating the functionality of the software or network after upgrades or adjustments.

FIG. 11B illustrates a graph 1100b depicting a functionality validation of the number of quality of service (QoS) flows successfully created, and sampled at an SMF pool according to an embodiment of the disclosure.

Referring to FIG. 11B, a graph 1100b may include the X-axis representing the actual values and predicted values over a given time period or event sequence. The Y-axis represents the number of QoS flows successfully created. The graph 1100b provides the comparison between the actual number 1104a of QoS flows successfully created and the predicted number 1104b as forecasted by the ML model. This allows for evaluating the accuracy of the predictions and determining how effectively the SMF pool 608 is handling the creation of QoS flows, which is critical for ensuring network service quality and performance. The validation may be crucial after the software upgrades or operational changes to verify that the network behaves as expected in managing the QoS flows.

FIG. 11C illustrates a graph 1100c depicting stability validation of RAM usage, sampled at a virtual network function (VNF) according to an embodiment of the disclosure.

Referring to FIG. 11C, an X-axis may include actual values 1106a and predicted values 1106b for the RAM usage across different points in time or events. The Y-axis represents RAM usage percentage, indicating how much of the available RAM is being utilized by the VNF over time. The graph 1100b provides the comparison of the actual RAM usage observed in the VNF with the predicted RAM usage as forecasted by the system's ML models. The stability validation may ensure that the VNF's resource consumption remains within expected limits following software upgrades or other changes, helping to detect anomalies or inefficiencies in RAM usage.

FIG. 11D illustrates a graph 1100d depicting stability validation of CPU usage, sampled at a VNF according to an embodiment of the disclosure.

Referring to FIG. 11D, the X-axis may include actual values 1108a and predicted values 1108b for the CPU usage across different points in time or events. The Y-axis represents CPU usage percentage, indicating how much of the available CPU is being utilized by the VNF over time. The graph 1100b provides the comparison of the actual CPU usage observed in the VNF with the predicted CPU usage as forecasted by the system's ML models. The stability validation may ensure that the VNF's resource consumption remains within expected limits following software upgrades or other changes, helping to detect anomalies or inefficiencies in CPU usage.

According to an embodiment of the disclosure, disclosed herein is an artificial intelligence (AI) assisted method to study and analyze using the MDAS framework to facilitate the successful software upgrade validation and topology mapping. In an embodiment of the disclosure, The MDAS framework uses key performance indicators (KPIs) and offers reliable and efficient successful software upgrades, thereby improving the overall operational efficiency of the operator. In some embodiments of the disclosure, in case of software upgrade failure, the MDAS producer may provide a distinguished node of a node that may take-over the traffic from a target node. In some embodiments of the disclosure, information related to take-over can also be provided as part of a recommendation in the SVAR.

The disclosure provides an automated process and offers increased reliability, reduced operational cost, and reduced software upgrade validation time. Accordingly, the stability and efficiency of software upgrades are realized. Moreover, the systems and methods of the disclosure may be used for the RAN) and core network functions. Thus, the MDAS-assisted software upgrade validation as described in the disclosure enhances software stability and efficiency and further improves overall operational expenditure efficiency.

In another embodiment of the disclosure, the MDAS framework uses the KPIs of a control plane (CP)/a User plane (UP) session like a round-trip time and a packet loss to offer reliable and efficient 5G sessions not limited to an ultra-reliable low-latency communication (URLLC) but other cases like mobile broadband (MBB) and mobile Internet of things (MIOT) communications.

The MDAS framework may provide the paths from different instances to optimally route the control and the user plane traffic from any source node to the target node. Alternatively, the information may also be provided as part of a recommendation in an MDAS framework report.

It is appreciated that the details provided are not limited to the user plane and the control plane mentioned in the disclosure. The details are also applicable for multiple other user planes and control planes, and the associated messages.

According to an embodiment of the disclosure, disclosed herein the MDAS producer deploys the ML models to continuously monitor the KPI for any upgrade and degrade and keep the consumer informed about any changes. The entire process is automated and offers increased reliability and reduced operational cost with the SLA guarantee for critical flows. Hence it is business-critical to deploy ML-assisted network topology mapping to meet the QFI Value of service. The stability and efficiency of network topology mapping are realized, and the solution may be used for the RAN and core network functions. The stability of service flow and overall operational expenditure efficiency are enhanced with AI/ML automation.

According to an embodiment of the disclosure, a method for performing validation of a software upgrade at a network entity (NE) utilizing a management data analytics service (MDAS) producer, comprise predicting, using a machine learning (ML) model, a first set of key performance indicators (KPIs) required to perform validation of the software upgrade, performing the software upgrade at the NE, determining a second set of KPIs associated with the NE after performing the software upgrade at the NE, comparing the predicted first set of KPIs and the determined second set of KPIs, and validating the software upgrade at the NE based on the comparison.

For example, a successful validation corresponds to an indicative prediction of a successful software upgrade at the NE for a future point of time.

For example, in response to an unsuccessful validation, the method comprises determining a node identifier (ID) of a neighbouring NE to offload traffic associated with the NE.

For example, the NE corresponds to a radio access network (RAN) node.

For example, the first and second set of KPIs comprises one or more functionality-related KPIs and one or more resource-usage-related KPIs. The one or more functionality-related KPIs comprise one or more handover success rate (HOSR), one or more dropped call rate (DCR), one or more blocking probability (BP), and one or more packet delay variation (PDV). The one or more resource-usage-related KPIs comprises system power, temperature, and hardware resource usage.

For example, the method comprises sending a validation analytics request of the NE to the MDAS producer, and receiving a software validation analytics report (SVAR) in response to the validation analytics request of the NE.

For example, the SVAR comprises an upgrade status. The upgrade status comprises a Boolean attribute indicating one of the successful software upgrade and an unsuccessful software.

According to an embodiment of the disclosure, a method for determining a network path mapping at a network entity (NE) utilizing a management data analytics service (MDAS) producer, comprises receiving network traffic information indicating network performance metrics for network traffic of one or more network paths on a network, predicting, using a machine learning (ML) model, a plurality of key performance indicators (KPIs) based on the received network traffic information, and determining one or more optimal network paths based on the predicted plurality of KPIs.

For example, the plurality of KPIs comprises one or more functionality-related KPIs and one or more resource-usage-related KPIs.

For example, the method comprises updating a pre-stored dataset of the plurality of KPIs based on the received network traffic information.

For example, the network performance metrics comprises one or more of a round trip time, a packet loss, and latency.

For example, the method comprises generating a dataset of one or more determined optimal network paths and the received network traffic information to manage processing load at the NE. The one or optimal network paths comprises one or more control plane paths, one or more user plane paths, and end-to-end (E2E) paths.

For example, the NE corresponds to a radio access network (RAN) node.

For example, the MDAS producer is configured to analyze the network performance metrics to support service-level specifications (SLS) assurance. The SLS assurance comprises service experience analysis, network slice throughput analysis, network slice traffic prediction, and end-to-end latency analysis.

For example, the method comprises sending the predicted plurality of KPIs to the MDAS producer. The predicted plurality of KPIs comprises at least one data network (DN) identifier (ID) of the NE, an average round trip delay, an incoming general packet radio service (GPRS) tunnelling protocol (GTP) packet loss, an outgoing GTP packet loss, reliability, incoming representational state transfer (REST) packet loss, and outgoing REST packet loss, and receiving a network topology mapping report (NTMR) in response to sending the predicted plurality of KPIs.

For example, the NTMR comprises an identifier of analytics, analytics output generation time, peer information, a peer identifier, a round-trip time, packet loss, reliability, and an interface type.

For example, the method comprises monitoring the predicted plurality of KPIs at the NE for the one or more optimal network paths.

For example, the method comprises assigning control plane traffic and user plane traffic according to a QoS flow identifier (QFI) value of service based on the predicted KPI.

According to an embodiment of the disclosure, a system for performing validation of a software upgrade at a network entity (NE) utilizing a management data analytics service (MDAS) producer, comprises memory, at least one processor coupled to the memory. The at least one processor configured to predict, using a machine learning (ML) model, a first set of key performance indicators (KPIs) required to perform validation of the software upgrade, perform the software upgrade at the NE, determine a second set of KPIs associated with the NE after performing the software upgrade at the NE, compare the predicted first set of KPIs and the determined second set of KPIs, and validate the software upgrade at the NE based on the comparison.

For example, A successful validation corresponds to an indicative prediction of a successful software upgrade at the NE for a future point of time.

For example, in response to an unsuccessful validation, the at least one processor configured to determine a node identifier (ID) of a neighbouring NE to offload traffic associated with the NE.

For example, the NE corresponds to a radio access network (RAN) node.

For example, the first set of KPIs comprises one or more functionality-related KPIs. The one or more functionality-related KPIs comprise one or more handover success rate (HOSR) KPIs, one or more dropped call rate (DCR), one or more blocking probability (BP), and one or more packet delay variation (PDV). The one or more resource-usage-related KPIs comprises system power, temperature, and hardware resource usage.

For example, the at least one processor is configured to send a validation analytics request of the NE to the MDAS producer, and receive a software validation analytics report (SVAR) in response to the validation analytics request of the NE.

For example, the SVAR comprises an upgrade status. The upgrade status comprises a Boolean attribute indicating one of the successful software upgrade and an unsuccessful software.

According to an embodiment of the disclosure, a system for determining a network path mapping at a network entity (NE) utilizing a management data analytics service (MDAS) producer, comprises memory, at least one processor coupled to the memory. The at least one processor configured to receive network traffic information indicating network performance metrics for network traffic of one or more network paths on a network, predict, using a machine learning (ML) model, a plurality of key performance indicators (KPIs) based on the received network traffic information, and determine one or more optimal network paths based on the predicted plurality of KPIs.

For example, the plurality of KPIs comprises one or more functionality-related KPIs and one or more resource-usage-related KPIs. The one or more functionality-related KPIs comprises performance management KPIs related information. The one or more resource usage-related KPIs comprises resource uptime information.

For example, the at least one processor is configured to update a pre-stored dataset of the plurality of KPIs based on the received network traffic information.

For example, the network performance metrics comprises one or more of a round trip time and a packet loss.

For example, the at least one processor is configured to generate a dataset of one or more determined optimal network paths and the received network traffic information to manage processing load at the NE. The one or optimal network paths comprises one or more control plane paths, one or more user plane paths, and End-to-End (E2E) paths.

For example, the NE corresponds to a radio access network (RAN) node.

For example, the MDAS producer is configured to analyze the network performance metrics to support service-level specifications (SLS) assurance. The SLS assurance comprises service experience analysis, network slice throughput analysis, network slice traffic prediction, and end-to-end latency analysis.

For example, the at least one processor is configured to send the predicted plurality of KPIs to the MDAS producer. The predicted plurality of KPIs comprises at least one data network (DN) identifier (ID) of the NE, an average round trip delay, an incoming general packet radio service (GPRS) tunnelling protocol (GTP) packet loss, an outgoing GTP packet loss, reliability, incoming representational state transfer (REST) packet loss, and outgoing REST packet loss, and receive a network topology mapping report (NTMR) in response to sending the predicted plurality of KPIs.

For example, the NTMR comprises an identifier of analytics, analytics output generation time, peer information, a peer identifier, a round-trip time, packet loss, reliability, and an interface type.

For example, the at least one processor is configured to monitor the predicted plurality of KPIs at the NE for the one or more optimal network paths.

For example, the at least one processor is configured to assign control plane traffic and user plane traffic according to a QoS flow identifier (QFI) value of service based on the predicted KPI.

According to an embodiment of the disclosure, a method performed by a network node for a management data analytics service (MDAS), comprises obtain network traffic information indicating network performance metrics for network traffic of one or more network paths on a network, obtain, using a machine learning (ML) model, a plurality of key performance indicators (KPIs) based on obtained network traffic information, and determining at least one network path based on the obtained plurality of KPIs.

For example, the plurality of KPIs comprises one or more functionality-related KPIs and one or more resource-usage-related KPIs.

For example, the method comprises updating a pre-stored dataset of the plurality of KPIs based on the obtained network traffic information.

For example, the network performance metrics comprises one or more of a round trip time, a packet loss, and latency.

For example, the method comprises generating a dataset of the at least one network path and the received network traffic information to manage processing load at the NE. The at least one network path comprises one or more control plane paths, one or more user plane paths, and end-to-end (E2E) paths.

For example, the NE corresponds to a radio access network (RAN) node.

For example, the network node for the MDAS is configured to analyze the network performance metrics to support service-level specifications (SLS) assurance. The SLS assurance comprises service experience analysis, network slice throughput analysis, network slice traffic prediction, and end-to-end latency analysis.

For example, the method comprises sending the predicted plurality of KPIs to the MDAS producer. The predicted plurality of KPIs comprises at least one data network (DN) identifier (ID) of the NE, an average round trip delay, an incoming general packet radio service (GPRS) tunnelling protocol (GTP) packet loss, an outgoing GTP packet loss, reliability, incoming representational state transfer (REST) packet loss, and outgoing REST packet loss, and receiving a network topology mapping report (NTMR) in response to sending the predicted plurality of KPIs.

For example, the NTMR comprises an identifier of analytics, analytics output generation time, peer information, a peer identifier, a round-trip time, packet loss, reliability, and an interface type.

For example, the method comprises monitoring the predicted plurality of KPIs at the NE for the one or more optimal network paths.

For example, the method comprises assigning control plane traffic and user plane traffic according to a QoS Flow identifier (QFI) value of service based on the predicted KPI.

According to an embodiment of the disclosure, a network node for a management data analytics service (MDAS), comprises memory comprising one or more storage media, storing instructions, and at least one processor comprising processing circuitry. The instructions, when executed by the at least one processor individually or collectively, the network node to obtain network traffic information indicating network performance metrics for network traffic of one or more network paths on a network, obtain, using a machine learning (ML) model, a plurality of key performance indicators (KPIs) based on the obtained network traffic information, and determine at least one network path based on the obtained plurality of KPIs.

For example, the plurality of KPIs comprises one or more functionality-related KPIs and one or more resource-usage-related KPIs.

For example, the instructions, when executed by the at least one processor individually or collectively, the network node to update a pre-stored dataset of the plurality of KPIs based on the obtained network traffic information.

For example, the network performance metrics comprises one or more of a round trip time and a packet loss.

According to an embodiment, a method performed by a network node for a management data analytics service (MDAS) may comprise obtaining network traffic information indicating network performance metrics for network traffic of one or more network paths on a network, obtaining, using a machine learning (ML) model, a plurality of key performance indicators (KPIs) based on obtained network traffic information, and determining at least one network path based on the obtained plurality of KPIs.

For example, the plurality of KPIs comprises one or more functionality-related KPIs, and one or more resource-usage-related KPIs.

For example, the method may comprise updating a pre-stored dataset of the plurality of KPIs based on the obtained network traffic information.

For example, the network performance metrics may comprise one or more of a round trip time, a packet loss, and latency.

For example, the method may comprise generating a dataset of the at least one network path and the received network traffic information to manage processing load at the NE. The at least one network path may comprise one or more control plane paths, one or more user plane paths, and end-to-end (E2E) paths.

For example, the NE may correspond to a radio access network (RAN) node.

For example, the network node for the MDAS may be configured to analyze the network performance metrics to support service-level specifications (SLS) assurance. The SLS assurance may comprise service experience analysis, network slice throughput analysis, network slice traffic prediction, and end-to-end latency analysis.

For example, the method may comprise sending the predicted plurality of KPIs to the MDAS, wherein the predicted plurality of KPIs comprises at least one data network (DN) identifier (ID) of the NE, an average round trip delay, an incoming general packet radio service (GPRS) tunnelling protocol (GTP) packet loss, an outgoing GTP packet loss, reliability, incoming representational state transfer (REST) packet loss, and outgoing REST packet loss, and receiving a network topology mapping report (NTMR) in response to sending the predicted plurality of KPIs.

For example, the NTMR may comprise an identifier of analytics, analytics output generation time, peer information, a peer identifier, a round-trip time, packet loss, reliability, and an interface type.

For example, the method may comprise monitoring the predicted plurality of KPIs at the NE for one or more optimal network paths.

For example, the method may comprise assigning control plane traffic and user plane traffic according to a QoS flow identifier (QFI) value of service based on the predicted KPI.

According to an embodiment, a network node for a management data analytics service (MDAS), may comprise memory, comprising one or more storage media, storing instructions, and at least one processor, comprising processing circuitry, communicatively coupled to the memory. The instructions, when executed by the at least one processor individually or collectively, may cause the network node to obtain network traffic information indicating network performance metrics for network traffic of one or more network paths on a network, obtain, using a machine learning (ML) model, a plurality of key performance indicators (KPIs) based on the obtained network traffic information, and determine at least one network path based on the obtained plurality of KPIs.

For example, the plurality of KPIs may comprise one or more functionality-related KPIs, and one or more resource-usage-related KPIs.

For example, the instructions, when executed by the at least one processor individually or collectively, further cause the network node to update a pre-stored dataset of the plurality of KPIs based on the obtained network traffic information.

For example, the network performance metrics may comprise one or more of a round trip time, and a packet loss.

For example, the instructions, when executed by the at least one processor individually or collectively, may cause the network node to generate a dataset of the at least one network path and the received network traffic information to manage processing load at the NE. The at least one network path may comprise one or more control plane paths, one or more user plane paths, and end-to-end (E2E) paths.

For example, the NE may correspond to a radio access network (RAN) node.

For example, the network node for the MDAS may be configured to analyze the network performance metrics to support service-level specifications (SLS) assurance. The SLS assurance may comprise service experience analysis, network slice throughput analysis, network slice traffic prediction, and end-to-end latency analysis.

According to an embodiment, one or more non-transitory computer-readable storage media may store one or more computer programs including computer-executable instruction. The computer-executable instruction, when executed by one or more processors of a network node for a management data analytics service (MDAS) individually or collectively, may cause the network node to perform operations. The operations may comprise obtaining network traffic information indicating network performance metrics for network traffic of one or more network paths on a network, obtaining, using a machine learning (ML) model, a plurality of key performance indicators (KPIs) based on the obtained network traffic information, and determining at least one network path based on the obtained plurality of KPIs.

For example, the plurality of KPIs may comprise one or more functionality-related KPIs, and one or more resource-usage-related KPIs.

According to an embodiment, a method performed by a system for performing validation of a software upgrade at a Network Entity (NE) utilizing a Management Data Analytics Service (MDAS) producer, may comprise predicting, using a machine learning (ML) model, a first set of key performance indicators (KPIs) required to perform validation of the software upgrade, performing the software upgrade at the NE, determining a second set of KPIs associated with the NE after performing the software upgrade at the NE, comparing the predicted first set of KPIs and the determined second set of KPIs, and validating the software upgrade at the NE based on the comparison.

For example, a successful validation may correspond to an indicative prediction of a successful software upgrade at the NE for a future point of time.

For example, in response to an unsuccessful validation, the method may comprise determining a node Identifier (ID) of a neighboring NE to offload traffic associated with the NE.

For example, the NE may correspond to a radio access network (RAN) node.

For example, the method may comprise sending a validation request of the NE to the MDAS producer, and receiving a software validation report in response to the validation request of the NE.

In this application, unless specifically stated otherwise, the use of the singular includes the plural and the use of “or” means “and/or.” Furthermore, use of the terms “including” or “having” is not limiting. Any range described herein will be understood to include the endpoints and all values between the endpoints. Features of the disclosed embodiments may be combined, rearranged, omitted, or the like, within the scope of the disclosure to produce additional embodiments. Furthermore, certain features may sometimes be used to advantage without a corresponding use of other features.

While at least the embodiment has been presented in the foregoing detailed description, it should be appreciated that a vast number of variations exist.

For one or more embodiments of the disclosure, at least one of the components set forth in one or more of the preceding figures may be configured to perform one or more operations, techniques, processes, and/or methods as set forth herein. For example, a processor (e.g., baseband processor) as described herein in connection with one or more of the preceding figures may be configured to operate in accordance with one or more of the examples set forth herein. For another example, circuitry associated with a UE, base station, network element, or the like, as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

The methods according to various embodiments described in the claims and/or the specification of the disclosure may be implemented in hardware, software, or a combination of hardware and software.

When implemented by software, a computer-readable storage medium storing one or more programs (software modules) may be provided. One or more programs stored in such a computer-readable storage medium (e.g., non-transitory storage medium) are configured for execution by one or more processors in an electronic device. The one or more programs include instructions that cause the electronic device to execute the methods according to embodiments described in the claims or specification of the disclosure.

Such a program (e.g., software module, software) may be stored in random-access memory, non-volatile memory including flash memory, read only memory (ROM), electrically erasable programmable read only memory (EEPROM), magnetic disc storage device, compact disc-ROM (CD-ROM), digital versatile discs (DVDs), other types of optical storage devices, or magnetic cassettes. Alternatively, it may be stored in memory configured with a combination of some or all of the above. In addition, respective constituent memories may be provided in a multiple number.

Further, the program may be stored in an attachable storage device that can be accessed via a communication network, such as e.g., Internet, Intranet, local area network (LAN), wide area network (WAN), or storage area network (SAN), or a communication network configured with a combination thereof. Such a storage device may access an apparatus performing an embodiment of the disclosure through an external port. Further, a separate storage device on the communication network may be accessed to an apparatus performing an embodiment of the disclosure.

In the above-described specific embodiments of the disclosure, a component included therein may be expressed in a singular or plural form according to a proposed specific embodiment. However, such a singular or plural expression may be selected appropriately for the presented context for the convenience of description, and the disclosure is not limited to the singular form or the plural elements. Therefore, either an element expressed in the plural form may be formed of a singular element, or an element expressed in the singular form may be formed of plural elements.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method of any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a network node for a management data analytics service (MDAS), the method comprising:
obtaining network traffic information indicating network performance metrics for network traffic of one or more network paths on a network;
obtaining, using a machine learning (ML) model, a plurality of key performance indicators (KPIs) based on obtained network traffic information; and
determining at least one network path based on the obtained plurality of KPIs.

2. The method of claim 1, wherein the plurality of KPIs comprises:
one or more functionality-related KPIs; and
one or more resource-usage-related KPIs.

3. The method of claim 1, further comprising:
updating a pre-stored dataset of the plurality of KPIs based on the obtained network traffic information.

4. The method of claim 1, wherein the network performance metrics comprises one or more of a round trip time, a packet loss, and latency.

5. The method of claim 1, further comprising:
generating a dataset of the at least one network path and the received network traffic information to manage processing load at the NE,
wherein the at least one network path comprises:
one or more control plane paths,
one or more user plane paths, and
end-to-end (E2E) paths.

6. The method of claim 1, wherein the NE corresponds to a radio access network (RAN) node.

7. The method of claim 1,
wherein the network node for the MDAS is configured to analyze the network performance metrics to support service-level specifications (SLS) assurance, and
wherein the SLS assurance comprises:
service experience analysis;
network slice throughput analysis;
network slice traffic prediction; and
end-to-end latency analysis.

8. The method of claim 1, further comprising:
sending the predicted plurality of KPIs to the MDAS, wherein the predicted plurality of KPIs comprises at least one data network (DN) identifier (ID) of the NE, an average round trip delay, an incoming general packet radio service (GPRS) tunnelling protocol (GTP) packet loss, an outgoing GTP packet loss, reliability, incoming representational state transfer (REST) packet loss, and outgoing REST packet loss; and
receiving a network topology mapping report (NTMR) in response to sending the predicted plurality of KPIs.

9. The method of claim 8, wherein the NTMR comprises:
an identifier of analytics;
analytics output generation time;
peer information, a peer identifier;
a round-trip time;
packet loss;
reliability; and
an interface type.

10. The method of claim 1, further comprising:
monitoring the predicted plurality of KPIs at the NE for one or more optimal network paths.

11. The method of claim 8, further comprising:
assigning control plane traffic and user plane traffic according to a QoS flow identifier (QFI) value of service based on the predicted KPI.

12. A network node for a management data analytics service (MDAS), comprising:
memory, comprising one or more storage media, storing instructions; and
at least one processor, comprising processing circuitry,
wherein the instructions, when executed by the at least one processor individually or collectively, cause the network node to:
obtain network traffic information indicating network performance metrics for network traffic of one or more network paths on a network,
obtain, using a machine learning (ML) model, a plurality of key performance indicators (KPIs) based on the obtained network traffic information, and
determine at least one network path based on the obtained plurality of KPIs.

13. The network node of claim 12, wherein the plurality of KPIs comprises:
one or more functionality-related KPIs; and
one or more resource-usage-related KPIs.

14. The network node of claim 12, wherein the instructions, when executed by the at least one processor individually or collectively, further cause the network node to update a pre-stored dataset of the plurality of KPIs based on the obtained network traffic information.

15. The network node of claim 12, wherein the network performance metrics comprises:
one or more of a round trip time; and
a packet loss.

16. A method performed by a system for performing validation of a software upgrade at a Network Entity (NE) utilizing a Management Data Analytics Service (MDAS) producer, comprising:
predicting, using a machine learning (ML) model, a first set of key performance indicators (KPIs) required to perform validation of the software upgrade;
performing the software upgrade at the NE;
determining a second set of KPIs associated with the NE after performing the software upgrade at the NE;
comparing the predicted first set of KPIs and the determined second set of KPIs; and
validating the software upgrade at the NE based on the comparison.

17. The method of claim 16, wherein a successful validation corresponds to an indicative prediction of a successful software upgrade at the NE for a future point of time.

18. The method of claim 16, wherein in response to an unsuccessful validation, the method comprises:
determining a node Identifier (ID) of a neighboring NE to offload traffic associated with the NE.

19. The method of claim 16, wherein the NE corresponds to a radio access network (RAN) node.

20. The method of claim 16, wherein the method comprises:
sending a validation request of the NE to the MDAS producer; and
receiving a software validation report in response to the validation request of the NE.
